(19) United States
(12) Patent Application Publication
(10) Pub. No.: US 2012/0255737 A1
(43) Pub. Date: Oct. 11, 2012

(54) APPARATUS, SYSTEM, AND METHODS FOR GENERATING A NON-PLUGGING HYDRATE SLURRY

(76) Inventors: Chad A. Broussard, Scott, LA (US); Tracy A. Fowler, Sugar Land, TX (US); Donald P. Shatto, Houston, TX (US); Douglas J. Turner, Humble, TX (US); Larry D. Talley, Friendswood, TX (US); Jason W. Lachance, Pearland, TX (US); David Greaves, Centennial, CO (US)

(21) Appl. No.: 13/464,611

(22) Filed: May 4, 2012

Related U.S. Application Data
(63) Continuation-in-part of application No. 12/162,477, filed on Jul. 28, 2008.
Application No. 12/162,477 is a continuation-in-part of application No. PCT/US2010/053328, filed on Oct. 20, 2010.
Application No. PCT/US2010/053328 is a continuation-in-part of application No. PCT/US2010/055842, filed on Nov. 8, 2010.
(60) Provisional application No. 61/262,371, filed on Nov. 18, 2009.
(60) Provisional application No. 61/393,199, filed on Oct. 14, 2010.
(60) Provisional application No. 61/407,292, filed on Oct. 27, 2010.

(51) Int. Cl. F17D 1/00; F16K 49/00; E21B 43/00

(52) U.S. Cl. 166/371; 137/334; 137/1

(57) ABSTRACT

Provided are apparatus, systems, and methods for generating a non-plugging hydrate slurry. The apparatus, systems, and methods for generating a hydrate slurry are useful for transport and/or production of wellstream hydrocarbons in subsea and arctic environments. The present invention provides methods of seeded or unseeded methods of making dry hydrates. Dry hydrates are made with or without the aid of chemicals and, preferably, with minimum use of rotating or other energized equipment.

### CROSS REFERENCE TO RELATED APPLICATIONS

This application is a continuation-in-part of U.S. application Ser. No. 12/162,477, filed Feb. 22, 2007, which claims priority to U.S. provisional application 60/782,449, filed Mar. 15, 2006, and U.S. provisional application 60/899,000, filed Feb. 2, 2007, and is a continuation-in-part of U.S. application PCT/US2010/053328, filed Oct. 20, 2010, which claims priority to U.S. provisional application 61/262,371, filed Nov. 18, 2009, and U.S. provisional application 61/393,199, filed Oct. 14, 2010, and is a continuation-in-part of U.S. application PCT/US2010/055842, filed Nov. 8, 2010, which claims priority to U.S. provisional application 61/407,292, filed Oct. 27, 2010, all of which are herein incorporated by reference in their entirety. This application is related to U.S. patent application Ser. No. 12/162,479, filed Feb. 13, 2007, which is herein incorporated by reference in its entirety.

### TECHNOLOGY FIELD

This disclosure relates generally to apparatus, systems, and methods for generating a non-plugging hydrate slurry. More particularly, this disclosure relates to apparatus, systems, and methods for seeded or unseeded generation of hydrate slurries to avoid hydrate plugging, wax deposition, and/or scaling without the aid of chemicals and with minimum use of rotating or energized equipment.

### BACKGROUND

This section introduces various aspects of the art, which may be associated with exemplary embodiments of the present disclosure. This discussion may assist in providing a framework to facilitate a better understanding of particular aspects of the present disclosure. Accordingly, it should be understood that this section should be read in this light, and not necessarily as admissions of prior art.

A challenging problem in oil and gas production is the presence of natural gas hydrates in pipelines and equipment. Also problematic is wax deposition in flow lines. Natural gas hydrate is an ice-like compound consisting of light hydrocarbon molecules encapsulated in an otherwise unstable water crystal structure. These hydrates form at high pressures and low temperatures wherever suitable gas and water are present. Such conditions are prevalent in “cold-flow” pipelines, where the pipeline and wellstream fluids are unheated, and the wellstream fluids are allowed to flow through the pipeline at the low ambient temperatures often found in subsea environments. Cold-flow delivery of wellstream fluids is highly desirable, however, since it avoids the cost of insulating the pipeline and heating the pipeline and the contained fluids, but wax-like deposits, scale, or gas hydrate crystals can deposit on cold-flow pipeline walls and in associated equipment, and in the worst case lead to complete plugging of the system. Costly and time-consuming procedures may be needed to restore flow again in a pipeline plugged with hydrates, scale, and/or wax.

In addition to the mere economic consequences, there are also numerous hazards connected to hydrate formation and removal, and there are known instances of pipeline ruptures and loss of human lives due to gas hydrates in pipelines. Although hydrate is generally thought of as a problem mostly for gas production, there is now ample evidence that it is also a significant problem for condensate and oil production systems. Wax deposition is also a costly problem when produced fluids naturally contain wax compounds, usually paraffin, that coat flow lines during liquid hydrocarbon production.

Several methods are known to prevent or eliminate hydrate formation and wax deposition, and subsequent problems in pipelines, valves and other production equipment, such as, for example, the processes disclosed in U.S. Patent Publication Nos. 20040176650 and 20040129609, U.S. Pat. No. 6,656,366. The article entitled “Continuous Gas Hydrate Formation Process by Static Mixing of Fluids,” Paper #1010 in 5th International Conference on Gas Hydrates, Trondheim, Norway, Jun. 13-16, 2005, by Tajima et al. contains additional background information.

Various conventional subsea processes exist, such as described in U.S. Pat. Pub. No. 2006/0175063, which describes a system for subsea hydrocarbon production flow in pipelines. The system chills a hydrocarbon production flow in a heat exchanger thereby causing solids to form, and then periodically removing deposits and placing them in a slurry utilizing a closed loop pig launching and receiving system.

Another conventional subsea process is taught in Patent Cooperation Treaty publication no. WO 00/25062, which describes a method for transporting a flow of fluid hydrocarbons containing water through a treatment and transportation system. The system introduces a flow of fluid hydrocarbons and particles of gas hydrates into a reactor.

Conventional subsea processes often include additional sections of pipe around the reactor. Such “bypass” sections add to the cost and complexity of the pipeline. In addition, certain sections of the pipeline, such as those sections directly adjacent each reactor, would remain un-piggable.

Current methods of preventing or eliminating hydrate plug formation using dry hydrates may involve, at a minimum, additional sections of pipe, recycle loops of dry hydrates, which also include pumps and/or grinders. In such methods, the continuous recycling of even dry hydrates in a recycle loop leads to the continued growth of the hydrates and the formation of larger and larger hydrates that, if not continuously ground into smaller hydrates using grinders or similar equipment, would ultimately grow large enough to cause plugging. Unfortunately, pumps and grinders are energized pieces of rotating equipment that can pose problems in subsea applications.

There are at least two problems with such subsea electrical rotating equipment. First, the reliability of rotating equipment is insufficient for long-term operation without multiple equipment replacements during the typical lifetime of a subsea pipeline. Second, electrical power transmission is limited in distance, thus limiting the distance over which some cold flow processes are useful.

Besides the problems of energized, rotating equipment in subsea applications, other problems occur with current cold flow methods, such as fluids forming “sticky hydrates”. If an unplanned shut-in occurs during the process, the reactor and possibly the main pipeline could experience a complete hydrate plug.

Thus, there is a need for improved methods of making dry hydrates without the aid of continuous injection of chemicals and with minimum use of rotating or other energized equipment.

### SUMMARY

Provided are apparatus, systems, and methods for generating a non-plugging hydrate slurry. The present invention is useful in any pipeline that: (a) transports hydrocarbon streams susceptible to buildup of wax, hydrates, scale, or combinations thereof, (b) transports hydrocarbon streams requiring chemical dosing, or (c) which are examined for corrosion surveillance. The provided apparatus, systems, and methods for generating a hydrate slurry are useful for transport and/or production of wellstream hydrocarbons from subsea and arctic environments.

Hydrate slurry generating apparatus include a pipeline, one or more heat exchangers disposed within the pipeline, and one or more static mixers disposed within the pipeline. A hydrate slurry generating apparatus disperses water and gas in wellstream fluids into smaller water and gas droplets that are relatively quickly and substantially converted into dry hydrates.

Hydrate slurry generating systems include a main pipeline in fluid communication with a first hydrocarbon source, and an auxiliary pipeline, i.e., cold-flow reactor, in fluid communication with the main pipeline. The auxiliary pipeline includes one or more heat exchangers disposed within the pipeline, and one or more static mixers disposed within the pipeline. Provided are systems for supporting multiple hydrocarbon sources wherein a hydrate slurry generating apparatus is provided for each hydrocarbon source.

Methods for producing hydrocarbons from a wellstream include the steps of transporting a flow of wellstream hydrocarbons to a hydrate slurry generating apparatus, forming a hydrate slurry with the apparatus, and transporting the hydrate slurry to a production facility.

### BRIEF DESCRIPTION OF THE FIGURES

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1(a) is a diagram of an exemplary embodiment of a hydrate slurry generating apparatus,

FIG. 1(b) is a diagram of an exemplary embodiment of a hydrate slurry generating apparatus,

FIGS. 2(a)-2(b) are cut-away illustrations of a static mixer apparatus in a first and second state in accordance with a first embodiment of the present invention;

FIGS. 3(a)-3(b) are cut-away illustrations of a static mixer apparatus in a first and second state in accordance with a second embodiment of the present invention;

FIGS. 4(a)-4(b) are cut-away illustrations of a static mixer apparatus in a first and second state in accordance with a third embodiment of the present invention;

FIGS. 5(a)-5(b) are cut-away illustrations of a static mixer apparatus in a first and second state in accordance with a fourth embodiment of the present invention;

FIGS. 6(a)-6(b) are cut-away illustrations of a static mixer apparatus in a first and second state in accordance with a fifth embodiment of the present invention;

FIG. 7(a) illustrates an exemplary system having a hydrate slurry generating apparatus in a main pipeline;

FIG. 7(b) illustrates exemplary system having a staged side stream having a primary reactor and a secondary reactor;

FIG. 7(c), illustrates a hydrate slurry generating apparatus having a parallel configuration of static mixers;

FIG. 8(a) is an illustration of an exemplary system for generating and recovering subsea dry hydrates,

FIG. 8(b) is an illustration of an exemplary system for generating and recovering subsea dry hydrates from multiple hydrocarbon sources,

FIG. 9(a) illustrates a utility floater umbilical to deliver dry hydrate to the wellstream;

FIG. 9(b) illustrates a simplified approach to dry hydrate reactor;

FIG. 10(a) illustrates a parity plot for water droplet Sauter mean diameter at two static mixer alignments;

FIG. 10(b) illustrates the ratio of Sauter mean diameter (SMD) to pipe diameter produced with a static mixer as a function of Weber number (We) for various liquid-liquid dispersions;

FIG. 11 illustrates total water droplet surface area with oil velocity at the outlet of a 5 element static mixer;

FIG. 12(a) illustrates the dendritic growth of hydrates on water droplets in a cold-flow reactor according to one or more embodiments of the present invention;

FIG. 12(b) illustrates the dendrites as separated from the water droplets shown in FIG. 12(a);

FIG. 13 illustrates a falling film dry hydrate seed reactor;

FIG. 14(a) illustrates a hydrate slurry generating apparatus in a main pipeline to increase heat and mass transfer during dry hydrate production;

FIG. 14(b) illustrates a rough-walled tube hydrate seed reactor;

FIG. 15(a) is a graph of distance required for a given heat duty to subcool a stream of fluids with varying inlet well temperatures;

FIG. 15(b) is a graph of latent heat of hydrate formation with varying fluid flow rate and watercut assuming 100% conversion of water to hydrate.

FIG. 16 is a graph of water as a percentage of liquids production from a well vs year of well production.

FIG. 17 is a graph of water as a percentage of liquids production from a well vs year of well production.

### DETAILED DESCRIPTION

In the following detailed description, specific embodiments of the disclosure are described in connection with preferred embodiments. However, to the extent that the following description is specific to a particular embodiment or a particular use of the present techniques, it is intended to be illustrative only and merely provides a concise description of the exemplary embodiments. Accordingly, the invention is not limited to the specific embodiments described below, but rather; the invention includes all alternatives, modifications, and equivalents falling within the true scope of the appended claims.

### Definitions

As used herein, the “a” or “an” entity refers to one or more of that entity. As such, the terms “a” (or “an”), “one or more”, and “at least one” can be used interchangeably herein unless a limit is specifically stated.

As used herein, the terms “comprising,” “comprises,” “comprised,” and “comprise” are open-ended transition terms used to transition from a subject recited before the term to one or elements recited after the term, where the element or elements listed after the transition term are not necessarily the only elements that make up of the subject.

As used herein, the terms “containing,” “contains,” and “contain” have the same open-ended meaning as “comprising,” “comprises,” and “comprise.”

As used herein, the term “production facility” refers to one or more structure(s) for carrying out activities on an inlet and/or an outlet of a production line. The production facility may be a floating vessel located over or near a subsea production well such as an FPSO (floating, production, storage and offloading vessel), an offshore fixed structure platform with production capabilities, an onshore structure with production capabilities and/or the like.

As used herein, the term “production line” may be a pipeline or other conduit for transporting wellstream fluid to a production facility.

As used herein, the term “production well” may refer to a well that is drilled into a reservoir and used to recover a hydrocarbon material.

As used herein, the terms “having,” “has,” and “have” have the same open-ended meaning as “comprising,” “comprises,” and “comprise.”

As used herein, the terms “including,” “includes,” and “include” have the same open-ended meaning as “comprising,” “comprises,” and “comprise.”

As used herein, the term “static mixer” may refer to an apparatus for (i) mixing a liquid and/or gas, and/or (ii) reducing the droplet size of a liquid and/or gas; wherein the mixing is not accomplished through motion of the apparatus but rather the motion of the liquid and/or gas facilitates the mixing.

As used herein, the term “wellstream fluid” may be a liquid and/or gas, such as hydrocarbon material, recovered from a production well.

### Description

Provided are apparatus, systems, and methods of generating a non-plugging hydrate slurry. The apparatus, systems, and methods for generating a hydrate slurry are useful for transport and/or production of wellstream hydrocarbons in subsea and arctic environments. The present invention provides seeded or unseeded methods of generating hydrates. Dry hydrates are made with or without the aid of chemicals and, preferably, with minimum use of rotating or other energized equipment.

While transporting hydrocarbons in subsea or arctic conditions, the present apparatus, systems, and methods increase the rate of cooling of hydrocarbons, which increases the hydrate formation driving force (subcooling). The present hydrate slurry generating apparatus form small water droplets and high shear/turbulence, which without being bound by theory, is believed to reduce heat transfer boundary layers, and thereby rapidly generate hydrates.

In addition to needing enhanced heat exchange/mixing capabilities, subsea operations may need additional artificial lift to transport the hydrate slurry. During hydrate formation/conversion, the hydrates uptake lighter gas components. This action increases the wellstream density and increases the wellstream viscosity.

Moreover, the present hydrate slurry generating system confines the hydrate formation area in a pipeline which results in better control of the cold flow process throughout the field life. Since the hydrate formation is localized, no additional equipment, e.g., static mixers, may be needed in other parts of a multiwall production system, e.g., the flowline, which may remain open for pigging if needed.

### Hydrate Slurry Generating Apparatus

Hydrate-slurry generating apparatus, also referred to as a cold-flow reactors, are composed of a pipeline, one or more heat exchangers disposed within the pipeline, and one or more static mixers disposed within the pipeline. The provided hydrate-slurry generating apparatus are useful with pipelines that: (a) transport hydrocarbon streams susceptible to buildup of wax, hydrates, scale, or combinations thereof, (b) transporting hydrocarbon streams requiring chemical dosing, or (c) which are examined for corrosion surveillance.

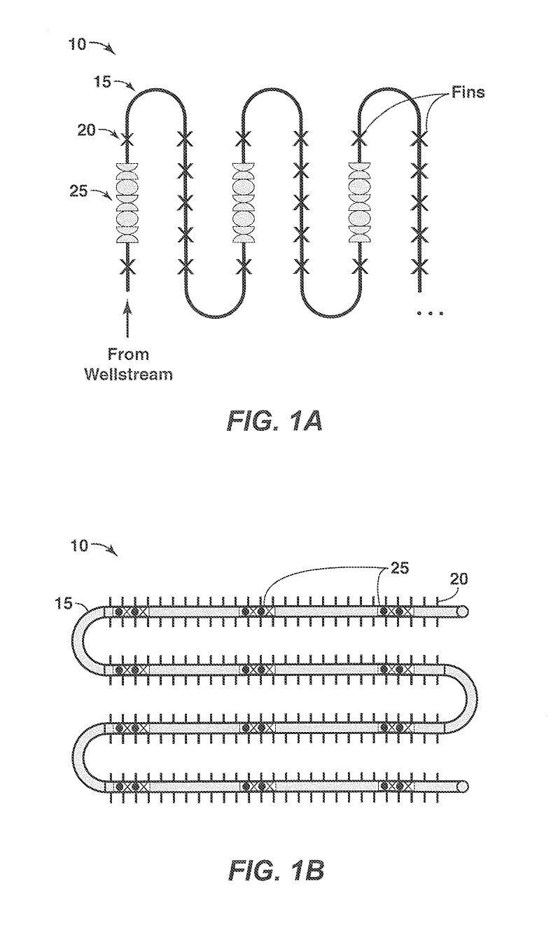

FIGS. 1(a) and 1(b) are diagrams of exemplary hydrate slurry generating apparatus. Referring to FIGS. 1(a) and 1(b), hydrate slurry generating apparatus 10 includes a pipeline 15, one or more heat exchangers 20, and one or more static mixer 25.

The pipeline is any conventional main pipeline, auxiliary pipeline, or tubing used for transporting hydrocarbons. The pipeline can be any size, shape, and length known to those skilled in the art. Exemplary pipelines designed as cold-flow reactors may be small-diameter pipe or tube having a diameter of from about 0.5 to about 30 inches, or more than about 10 cm, or about 0.5-10 cm, or about 0.5-5 cm, or about 1-3 cm. Without being limited by theory, it is believed that smaller diameter pipe increases the potential for jamming when transporting concentrated hydrate slurries. Further, with increasing pipe diameter, heat transfer decreases such that increasingly longer pipes are needed to remove the same amount of heat from a hydrocarbon stream.

Heat exchangers used in hydrate slurry generating apparatus are conventional devices that transfer heat from one medium to another. Exemplary heat exchangers include parallel heat exchangers, cross flow heat exchangers, counter flow heat exchangers, or combinations thereof. Preferably, heat exchangers maximize the surface area of the wall between the two mediums, i.e., warmer fluid and cooler fluid, while minimizing resistance to fluid flow through the exchanger. The heat exchanger's performance can also be improved by the addition of fins or corrugations in one or both directions, which increase surface area and may channel fluid flow or induce turbulence. Preferably, the heat exchangers are (a) a once-through, tube bank heat exchanger, (b) a tube bank heat exchanger that divide a mainstream into two or more smaller streams, (c) shell-and-tube heat exchangers, (d) plate heat exchangers, (e) fin heat exchangers, e.g., interior fins and/or exterior fins, or (f) combinations thereof.

Tube-bank, and shell-and-tube heat exchangers consist of a series of pipes or tubes. One set of these pipes contains the fluid that must be cooled. The second fluid, e.g., seawater or treated water from topsides that will be injected for reservoir maintenance or combinations thereof, runs over the pipes that are being cooled so that it can absorb the heat required. A set of pipes is called the pipe bundle and can be made up of several types of pipes: plain, roughened interior, longitudinally finned, etc. Heat exchanger design considers, for example, pipe diameter, pipe thickness, pipe length, pipe pitch, pipe corrugation, pipe layout, and baffle design, if baffles are utilized.

For example, using a smaller pipe diameter makes the heat exchanger both economical and compact. However, smaller diameter pipe is more susceptible to fouling and jamming from solids formation. One or more embodiments of the present invention enable the use of small diameter pipe because hydrate fouling is avoided and the pipe may optionally be pigged. Tube thickness is selected to provide: room for corrosion, reduce or withstand flow-induced vibration, provide axial strength, provide hoop strength to withstand internal tube pressure, provide buckling strength to withstand overpressure in the shell. Preferably, heat exchangers have a small shell diameter and a longer tube length to reduce costs.

Fin-type heat exchangers include one or more metal protrusions, e.g., plates, typically aluminum or other high heat transfer material, to create a series of “fins”, which increase the heat transfer surface area. Heat is transferred from a warmer medium through a fin interface into an adjacent medium. Fins may also serve to increase the structural integrity of the heat exchanger and allow it to withstand high pressures while providing an extended surface area for heat transfer.

Fins may be any length, height, thickness, and shape. Four exemplary type of fins are: plain, which refer to simple straight-finned triangular or rectangular designs; herringbone, where the fins are placed sideways to provide a zig-zag path; and serrated and perforated which refer to cuts and perforations in the fins to augment flow distribution and improve heat transfer.

Exemplary heat exchangers are commercially available from Kenics and Komax.

Static mixers used in hydrate slurry generating apparatus are conventional static mixers know to those skilled in the art. Alternatively, static mixers are piggable static mixer apparatus that facilitate the pigging of a pipeline and/or heat exchanger without one or more of the drawbacks associated with the inclusion of bypass sections.

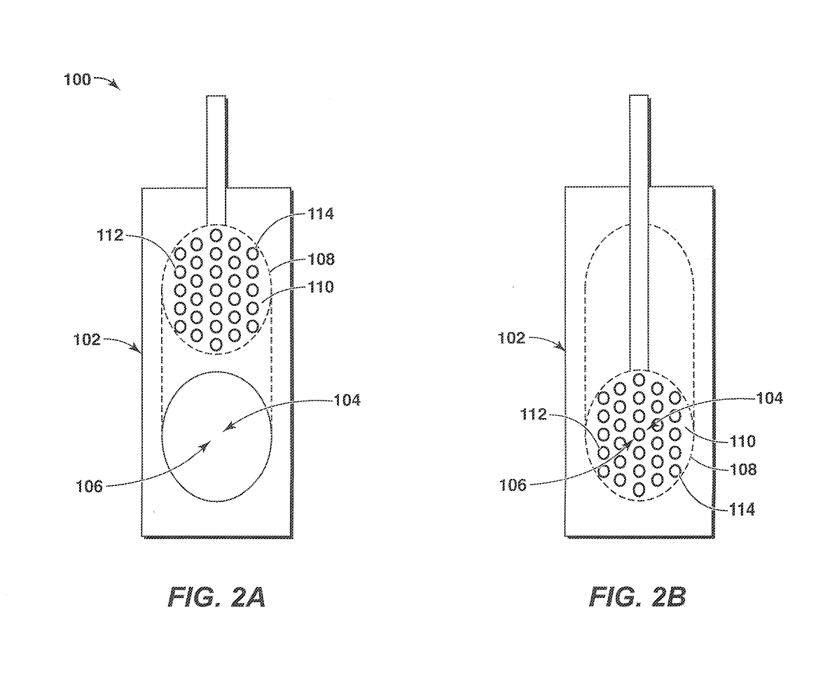

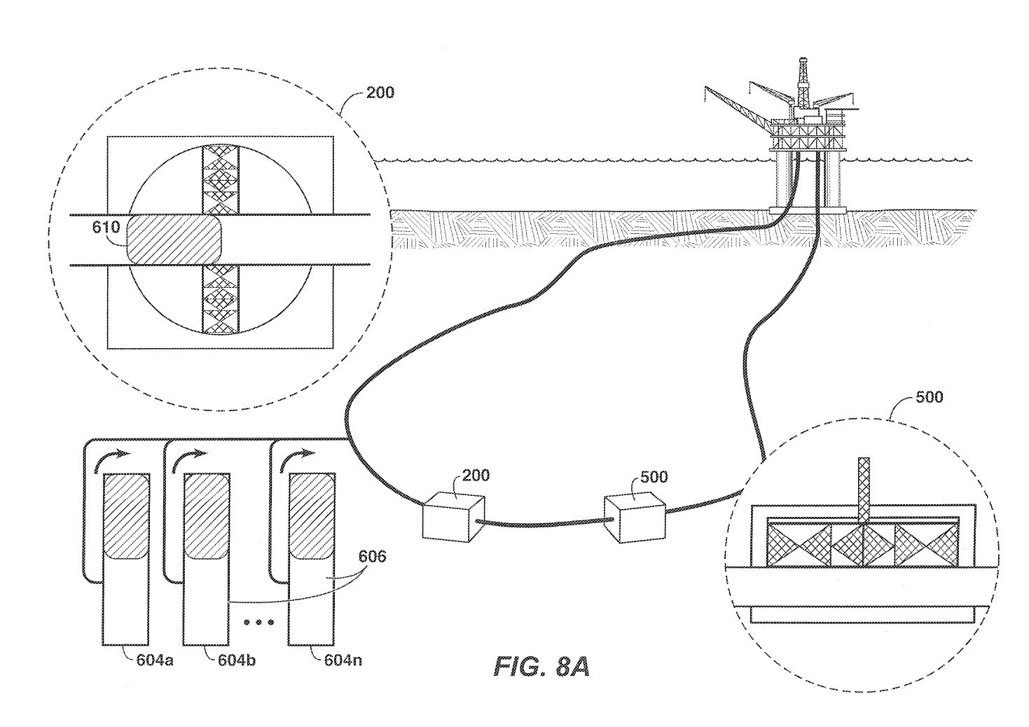

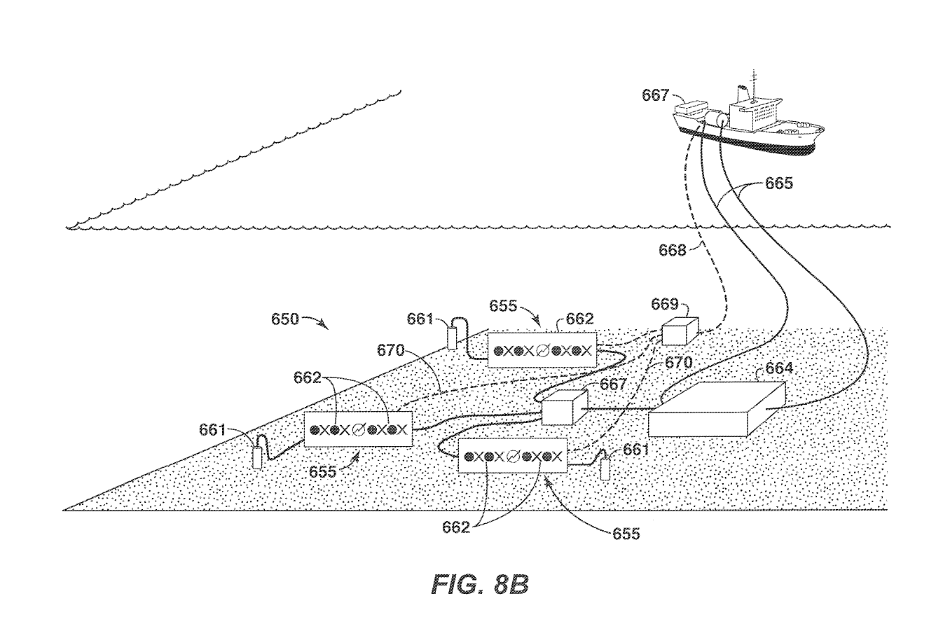

Referring now to FIGS. 2(a) and 2(b), cut-away illustrations are provided of a static mixer apparatus 100 in both a first 102 and second state 102′ in accordance with a first embodiment of the present invention. In general, the apparatus 100 comprises an inlet orifice 104 and an outlet orifice 106 in fluid communication with one another. A mechanism 108 is fluidly coupled between the inlet 104 and outlet 106 orifices. The mechanism 108 includes a retractable plate 110 which may include a plurality of holes 112. In at least one embodiment the holes 112, themselves, act to mix wellstream fluid passing there through to enhance formation of dry hydrates (i.e., the holes 112 themselves act as static mixers) in a cold-flow application, such as the application described in connection with FIGS. 8(a) and 8(b) (described below). In yet another embodiment, each hole 112 includes a static mixer 114 for mixing of wellstream fluid passing there through. While a single grouping of holes 112 is shown in FIGS. 1(a) and 1(b), one or more embodiments of the present invention may implement a plurality of groups of holes 112 and/or static mixers 114 arranged in any appropriate pattern to meet the design criteria of a particular application.

When the apparatus 100 is in the first state 102 the plate 110 is substantially extracted (i.e., removed) from the fluid flow such that the fluid flow between the inlet 104 and outlet 106 orifices is substantially unimpeded. In contrast, when the apparatus 100 is in the second state 102′, the plate 110 is inserted into the fluid flow such that the static mixer element (e.g., holes 112 and/or static mixers 114) impinges upon the fluid flow. While a single plate 110 is shown in FIGS. 1(a) and 1(b), any suitable number and configuration of plates 110 may be implemented to satisfy the design criteria of a particular application. For example, one or more embodiments may implement a plurality of plates 110 in series (i.e., stacked one above the other) and/or in parallel (i.e., stacked side by side). Furthermore, one or more of the plurality of plates 110 may include a unique (i.e., different as compared to the other plates 110) number of holes 112 and/or static mixers 114.

It may be appreciated, then, that a pig or other object may be passed substantially unimpeded through the apparatus 100 when the apparatus 100 (and therefore the mechanism 108) is configured in the first state 102. Likewise, the apparatus 100 may be placed in the second state 102′ when it is desirable to enhance mixing, formation of dry hydrates and/or emulsions (e.g., via the static mixer element) in a cold-flow application, and/or the like.

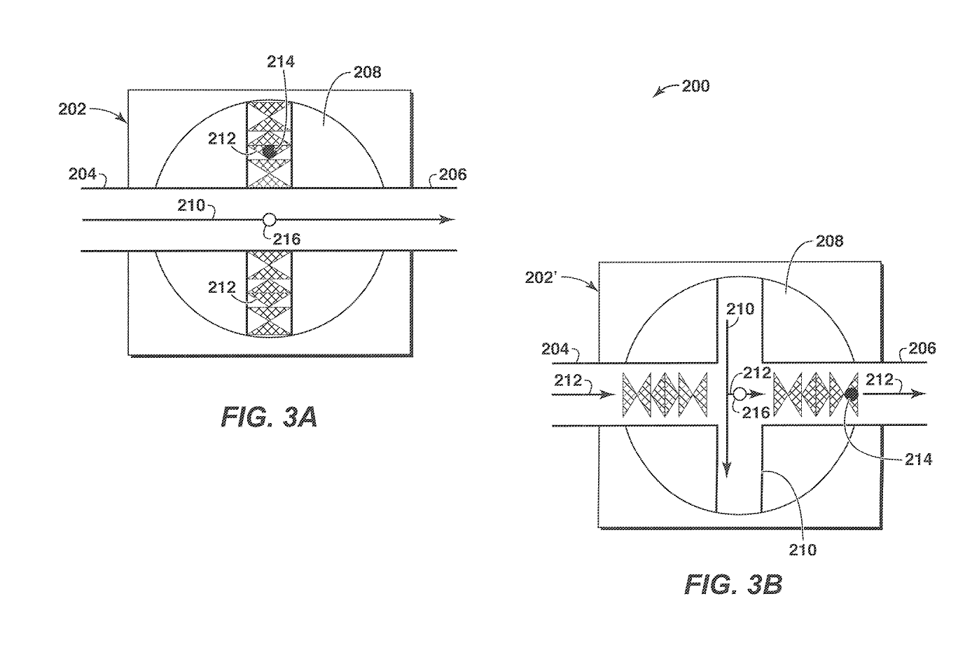

With reference to FIGS. 3(a) and 3(b), cut-away illustrations are provided of a static mixer apparatus 200 in both a first 202 and second state 202′ in accordance with a second embodiment of the present invention. In general, the static mixer apparatus 200 comprises an inlet orifice 204 and an outlet orifice 206 in fluid communication with one another. A mechanism 208 is fluidly coupled between the inlet 204 and outlet 206 orifices. The mechanism 208 includes a first channel 210 (preferably substantially devoid of obstructions) and a second channel 212 having one or more static mixer elements 214. In general the mechanism 208 rotates (clockwise and/or counterclockwise) on an axis 216 for selectively aligning (i.e., fluidly coupling) either the first 210 or second 212 channel with the inlet 204 and outlet 206 orifices. As such, fluid flow between the inlet 204 and outlet 206 orifices is substantially unimpeded when the apparatus 200 is in the first state 202 (corresponding to the first channel 210 being aligned with the inlet 204 and outlet 206 orifices) and a static mixer element 214 impinges upon the fluid flow when the apparatus 200 is in the second state 202′.

It may be appreciated, then, that a pig or other object may be passed substantially unimpeded through the apparatus 200 when the apparatus 200 (and therefore the mechanism 208) is configured in the first state 202. Likewise, the apparatus 200 may be placed in the second state 202′ when it is desirable to enhance mixing, formation of dry hydrates and/or emulsions (e.g., via the static mixer element 214) in a cold-flow application, and/or the like.

While two groupings of static mixers 214 are shown in the second channel 212, any appropriate quantity and arrangement of static mixers 214 may be implemented to satisfy the design criteria of a particular application as long as the static mixers 214 do not substantially impede flow through the first channel 210.

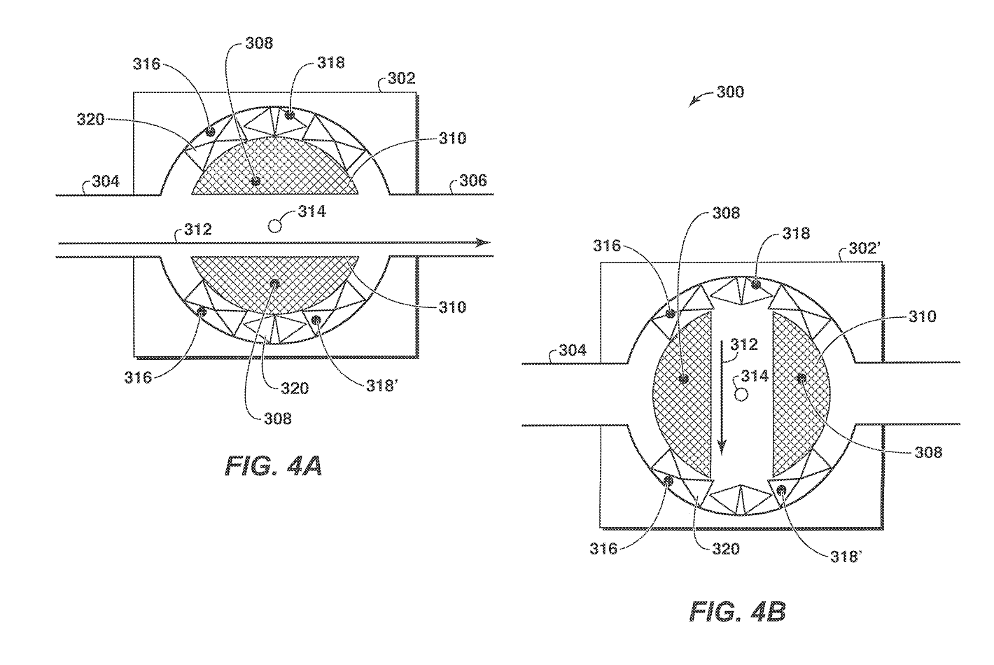

With reference to FIGS. 4(a) and 4(b), cut-away illustrations are provided of a static mixer apparatus 300 in both a first 302 and second state 302′ in accordance with a third embodiment of the present invention. In general, the static mixer apparatus 300 comprises an inlet orifice 304 and an outlet orifice 306 in fluid communication with one another. A mechanism 308 is fluidly coupled between the inlet 304 and outlet 306 orifices. The mechanism 308 includes a diverter 310 having a channel 312 (preferably substantially devoid of obstructions) for fluidly coupling the inlet 304 and outlet 306 orifices when the mechanism 308 is in the first state 302. The mechanism 308 may rotate (clockwise and/or counterclockwise) on an axis 314 between the first 302 and second 302′ state. In general, the axis 314 is substantially perpendicular to the channel 312.

The apparatus 300 further includes a static mixer element 316 comprised of one or more groups (i.e., sets) of static mixers (e.g., 318 and 318′). In a preferred embodiment, the static mixer element 316 comprises at least two groups 318, 318′ of static mixers 320.

However, any appropriate number of groups may be implemented to meet the design criteria of a particular application. Each group of one or more static mixer(s) 320 is fixedly mounted within the apparatus 300 such that the groups 318, 318′ do not rotate about axis 314. As such, fluid flow between the inlet 302 and outlet 304 orifices is substantially unimpeded when the apparatus 300 is in the first state 302 (corresponding to the channel 312 being aligned with the inlet 304 and outlet 306 orifices). In contrast, the diverter 310 directs the fluid flow around the diverter 310 and across the static mixer element 316 when the apparatus 300 is in the second state 302′. Such a design 300 may be particularly advantageous since it results in an extended length and reduced diameter through the static mixer element 316. Such characteristics of a static mixer element (e.g., 316) generally increase performance of the corresponding static mixers (e.g., 320).

It may be appreciated, then, that a pig or other object may be passed substantially unimpeded through the apparatus 300 when the apparatus 300 (and therefore the mechanism 308) is configured in the first state 302. Likewise, the apparatus 300 may be placed in the second state 302′ when it is desirable to enhance mixing, formation of dry hydrates and/or emulsions (e.g., via the static mixer element 316) in a cold-flow application, and/or the like.

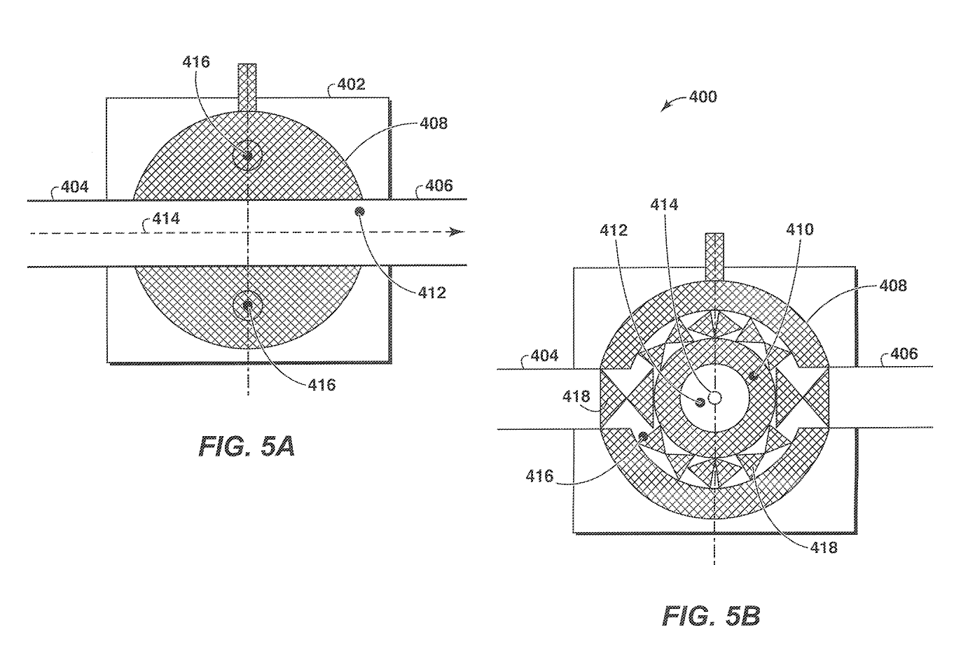

With reference to FIGS. 5(a) and 5(b), cut-away illustrations are provided of a static mixer apparatus 400 in both a first 402 and second state 402′ in accordance with a fourth embodiment of the present invention. In general, the static mixer apparatus 400 comprises an inlet orifice 404 and an outlet orifice 406 in fluid communication with one another. A mechanism 408 is fluidly coupled between the inlet 404 and outlet 406 orifices. The mechanism 408 includes a sphere or other radially symmetrical shape such as a cylinder 410 having a center channel 412 (preferably substantially devoid of obstructions) there through. The center channel 412 is substantially coincident with a center axis 414 of the sphere 410 and configured to fluidly couple the inlet 404 and outlet 406 orifices when the mechanism 408 is in the first state 402. In at least one embodiment the sphere 410 of the mechanism 408 rotates (clockwise and/or counterclockwise) between the first 402 and second 402′ state on an axis 415. In general, the axis 415 is substantially perpendicular to the center axis 414 and, therefore, the center channel 412.

The apparatus 400 further includes a static mixer element 416 comprised of one or more static mixers 418 fixedly coupled to an outer surface 420 of the sphere 410 and along at least a portion of a cross section (e.g., a circular cross section) of the sphere 410 such that the fluid flow is diverted through the static mixer element 416 when the mechanism is in the second state 402′ and the static mixer element 416 is substantially removed from the fluid flow when the mechanism is in the first state 402. That is, flow between the inlet 402 and outlet 404 orifices is substantially unimpeded when the apparatus 400 is in the first state 402 (corresponding to the channel 412 being aligned with the inlet 404 and outlet 406 orifices) and the fluid flow is forced through the static mixer element 416 when the mechanism is in the second state 402′. Such a design 400 may be particularly advantageous since it results in an extended length and reduced diameter through the static mixer element 416. Such characteristics of a static mixer element (e.g., 416) generally increase performance of the corresponding static mixers (e.g., 418).

It may be appreciated, then, that a pig or other object may be passed substantially unimpeded through the apparatus 400 when the apparatus 400 (and therefore the mechanism 408) is configured in the first state 402. Likewise, the apparatus 400 may be placed in the second state 402′ when it is desirable to enhance mixing, formation of dry hydrates and/or emulsions (e.g., via the static mixer element 416) in a cold-flow application, and/or the like.

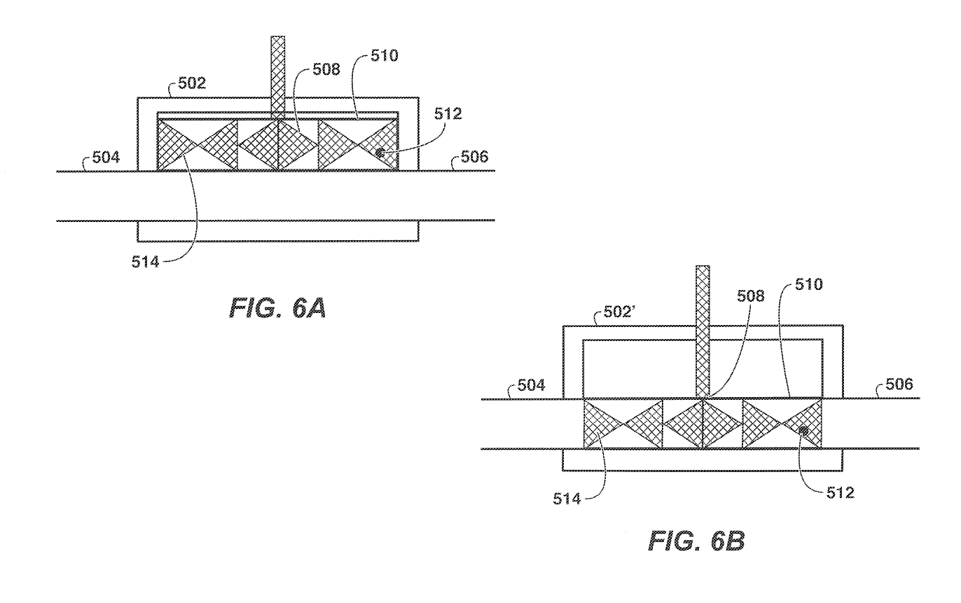

With reference to FIGS. 6(a) and 6(b), cut-away illustrations are provided of a static mixer apparatus 500 in both a first 502 and second state 502′ in accordance with a fifth embodiment of the present invention. In general, the static mixer apparatus 500 comprises an inlet orifice 504 and an outlet orifice 506 in fluid communication with one another. A mechanism 508 is fluidly coupled between the inlet 504 and outlet 506 orifices. The mechanism 508 includes a retractable channel 510 having a static mixer element 512 therein. Any number of static mixers 514 in any appropriate grouping and/or configuration may be implemented in connection with the static mixer element 512 to meet the design criteria of a particular application.

In general, the retractable channel 510 is configured such that it is substantially extracted from fluid flow when the apparatus 500 is in the first state 502. In contrast, the channel 510 is substantially inserted into the fluid flow when the apparatus 500 is in the second state 502′. As such, the retractable channel 510 is configured to divert substantially all of the fluid flow through the static mixer element 512 when the mechanism 508 is in the second state.

It may be appreciated, then, that a pig or other object may be passed substantially unimpeded through the apparatus 500 when the apparatus 500 (and therefore the mechanism 508) is configured in the first state 502. Likewise, the apparatus 500 may be placed in the second state 502′ when it is desirable to enhance mixing, formation of dry hydrates and/or emulsions (e.g., via the static mixer element 512) in a cold-flow application.

The piggable static mixers provided herein are useful in systems for generating dry hydrates and reducing wax deposition. While the insertion of static mixers into a pipeline may reduce the formation of undesirable wax deposits, the presence of a conventional in-line static mixer effectively eliminates the ability to pass a pig unimpeded through the pipeline. Accordingly, the piggable static mixers of the present invention are utilized in pipelines requiring pigging.

Heat exchangers and static mixers are combined and configured to facilitate hydrate slurry formation. For example, static mixers (“SM”) and heat exchangers (“HE”) can be aligned in any of the following “in-series” configurations: SM-HE, HE-SM, SM₁-SM₂-HE, HE₁-HE₂-SM, HE-SM₁-SM₂, SM-HE₁-HE₂, SM₁-[SM₍₂₎ . . . SM₍ₙ₎]-HE, HE₁-[HE₂ . . . HE₍ₙ₎]-SM, HE-SM₁-[SM₂ . . . SM₍ₙ₎], SM-HE₁-[HE₂ . . . HE₍ₙ₎], HE-SM-HE, SM-HE-SM, HE-[SM-HE]₍₁₎ . . . [SM-HE]₍ₙ₎, SM-[HE-SM]₍₁₎ . . . [HE-SM]₍ₙ₎, [HE₍₁₎ . . . HE₍ₙ₎]-[SM . . . SM₍ₙ₎]-[HE . . . HE₍ₙ₎], [SM . . . SM₍ₙ₎]-[HE . . . HE₍ₙ₎]-[SM . . . SM₍ₙ₎], and combinations thereof.

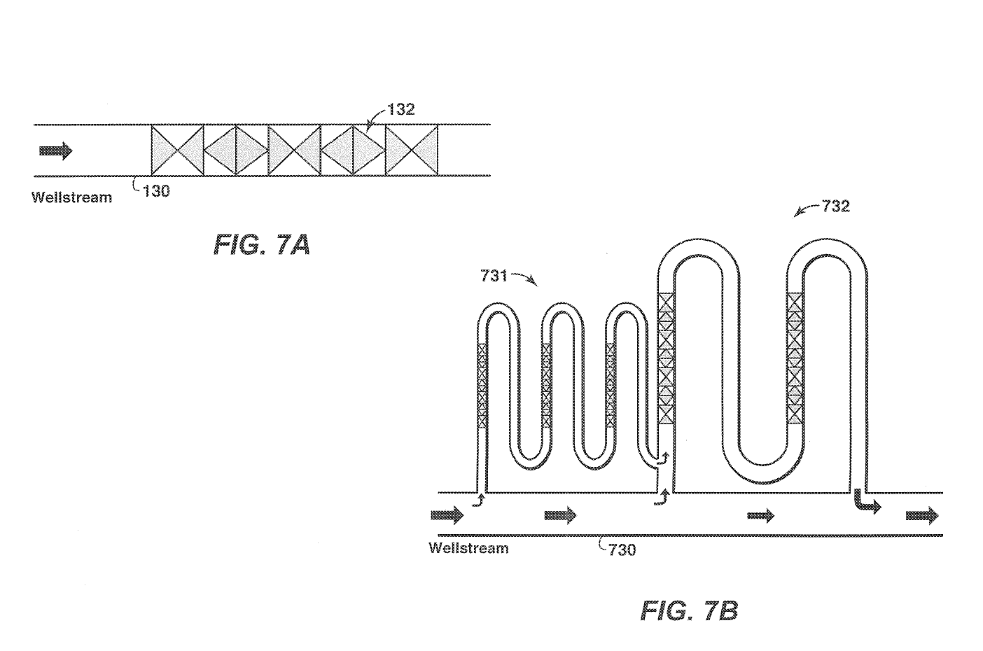

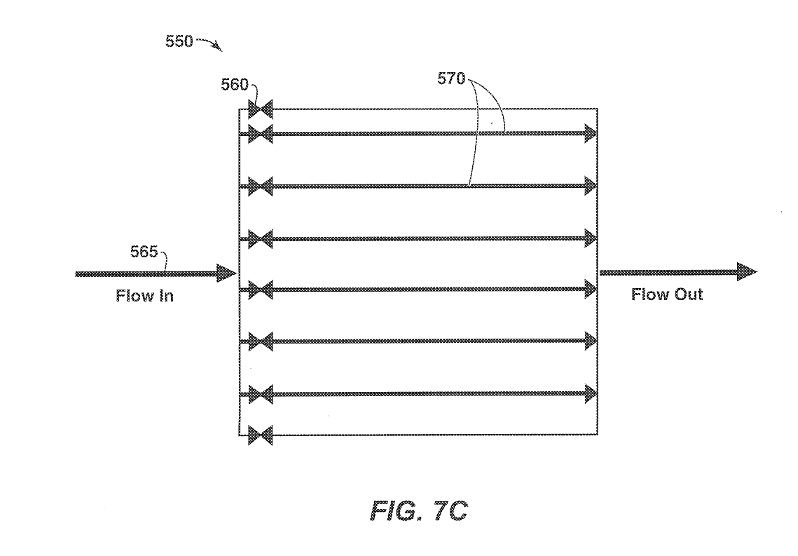

The foregoing “in-series” configurations may be combined as “in-parallel” configurations such that any in-series configuration can be applied in-parallel with one or more other in-series configuration. For example, the following three in-series configurations may be simultaneously run in a parallel configuration: (1) HE-SM₁-SM₂, (2) HE-SM-HE, and (3) SM-[HE-SM]₍₁₎ . . . [HE-SM]₍ₙ₎. Referring to FIG. 7(c), a hydrate slurry generating apparatus 550 exhibits a parallel configuration of static mixers 560. In a parallel configuration, a pipeline 565 is divided into a plurality of auxiliary pipelines 570, e.g., heat exchanger tubes. Cooling is achieved via contact of a cooling medium, e.g., sea water, with the plurality of auxiliary pipelines 570.

In one or more embodiments, hydrate slurry generating apparatus include one or more valves that control the flow of hydrocarbons through the pipeline to adjust for changing heat transfer requirements.

In one or more embodiments, one or more heat exchangers and one or more static mixers as described above are combined in a housing having an inlet and an outlet. The housing may optionally include a pump to urge the flow of a cooling medium, e.g., sea water, over a pipeline to facilitate removal of heat from a hydrocarbon flowing in the pipeline. The flow of the cooling medium may be adjusted with changing hydrate equilibrium conditions and would thereby reduce the effects of fouling on the exterior of the pipeline. This design also allows the heat exchanger to be more compact.

In one or more embodiments, one or more pumps are utilized to transport hydrate slurries. The pump may be a multiphase pump, or a liquid pump if the hydrocarbon phase equilibrium stays out of the two phase region. Preferably, the pump is used to achieve high hydrate slurry flow rates are maintained. Subsea pumps optionally provide means for artificial lift so that a hydrate slurry can be transported through the pipeline and up a riser. Preferably, pumps are not utilized for recirculation, but instead are intended for use to force the transportation of the hydrate slurry. The pump is positioned such that during shut-in conditions, the hydrate slurry and unconverted portions of the cold flow process continue without impedence. The recirculation also prevents hydrates from bedding and prevents coalescence of unconverted water before forming hydrate.

Those skilled in the art will appreciate that hydrate slurry generating apparatus may optionally include additional equipment, such as manifolds, valves, vessels, pipelines, and jumpers, etc.

### Hydrate Slurry Generating Systems

The present invention includes hydrate slurry generating systems composed of a main pipeline, an auxiliary pipeline, or both as follows: (a) one or more hydrate slurry generating apparatus are located in a main pipeline, such as shown in FIG. 7(a), (b) one or more hydrate slurry generating apparatus are located in an auxiliary pipe, i.e., reactor or cold-flow reactor, which is in fluid communication with a main pipeline, (c) one or more hydrate slurry generating apparatus are located in two or more auxiliary pipelines, i.e., primary reactor, secondary reactor, etc., which are each in fluid communication with a main pipeline, and which may be in fluid communication with each other, (d) one or more hydrate slurry generating apparatus are located in a main pipeline and one or more hydrate slurry generating apparatus are located in an auxiliary pipeline, which is in fluid communication with a main pipeline, or (e) one or more hydrate slurry generating apparatus are located in a main pipeline and one or more hydrate slurry generating apparatus are located in two or more auxiliary pipelines, which are each in fluid communication with a main pipeline, and which may be in fluid communication with each other. FIG. 7(b) shows an exemplary embodiment of configuration (c).

In systems having two or more auxiliary pipelines, the auxiliary pipelines can be the same size or different sizes. The two or more auxiliary pipelines are each independently located anywhere along the main pipeline.

In one or more embodiments of configuration (c), an outlet of the primary auxiliary pipeline may be in direct fluid communication with an inlet of the secondary auxiliary pipeline. Both primary and secondary auxiliary pipeline may have an inlet in fluid communication with the main pipeline. Similarly, both the primary and secondary auxiliary pipelines may have an outlet in fluid communication with the main pipeline. Alternatively, the secondary auxiliary pipeline may have an inlet in fluid communication with the first auxiliary pipeline, but no inlet in fluid communication with the main pipeline.

In embodiments where hydrate slurry generating apparatus are in an auxiliary pipeline, any amount of the hydrocarbon stream, e.g., wellstream, may be introduced to the auxiliary pipelines, such as less than 30% by volume of the full hydrocarbon stream. Preferably, no more than 5% by volume of the hydrocarbon stream is introduced to the auxiliary pipeline. Alternatively, no more than 1% by volume of the hydrocarbon stream is introduced to the auxiliary pipeline.

Auxiliary pipelines may be any size pipe, but are preferably smaller than the main pipeline. In a vertical configuration, the auxiliary pipelines may comprise alternating upward and downward flowing pipes, i.e., S-pattern. Hydrate generating apparatus may be installed in the upward flowing pipes, downward flowing pipes, or both upward and downward flowing pipes.

In one or more embodiments, the auxiliary pipeline includes a gas-fluid connection to a gas tank to allow a gas phase in the wellstream to be separated from the liquid phase of the wellstream.

In one or more embodiments, the auxiliary pipelines include a falling film reactor. The diverted portion of wellstream may be injected into the auxiliary pipeline along the walls of the reactor. The method further contemplates injecting water and high pressure gas into the falling film reactor to form a dry hydrate along the walls of the reactor. The injected water and gas may be separated from the dry hydrate sidestream slurry before the slurry is fed into the main pipeline. At least one hydrate slurry generating apparatus may be installed in the section of the main pipeline after a point where the dry hydrate sidestream is fed into the main pipeline.

Referring to FIG. 8(a), an exemplary system 600 is provided for generating and recovering subsea dry hydrates using a hydrate slurry generating apparatus in accordance with embodiments of the present invention. The system 600 may include a production facility 602, one or more subsea production well(s) 604 feeding wellstream fluid 606 into a production line 608 and/or hydrate slurry generating apparatus in accordance with one or more embodiments of the present invention (e.g., static mixer apparatuses 200, 500).

System 600 is an exemplary system in which one or more embodiments of the present invention may be advantageously implemented. More specifically, implementation of one or more embodiments of the present invention may facilitate the pigging (e.g., using pig 610) of the production line 608 without the need to implement bypass sections around the static mixers.

The hydrate slurry generating systems described herein may further optionally include a manifold in fluid communication with the first main pipeline and the one or more additional main pipelines.

The hydrate slurry generating systems described herein may further optionally include flowlines in fluid communication with: (a) the first main pipeline, (b) the one or more additional main pipelines, (c) a production facility, and/or (d) a source of pipeline pigs.

The hydrate slurry generating systems described herein may further optionally include a chemical injection system in fluid communication with an auxiliary pipeline.

The hydrate slurry generating systems described herein may further optionally include a production facility.

The hydrate slurry generating systems described herein may further optionally include one or more pumps. Optionally, a pump may be placed at the base of a riser instead of at the subsea production complex.

Hydrate slurry generating systems also include “multiple hydrocarbon source” systems which service more than one hydrocarbon source, such as a well, tank, reservoir, or basin. A typical multiple source system includes at least one hydrate slurry generating apparatus for each hydrocarbon source. An exemplary multiple source system includes: (a) a first main pipeline in fluid communication with a first hydrocarbon source, (b) a first auxiliary pipeline in fluid communication with the first main pipeline, wherein the first auxiliary pipeline includes a hydrate slurry generating apparatus of the present invention, (c) one or more additional main pipelines, which are each in fluid communication with one or more additional hydrocarbon sources, and (d) one or more additional auxiliary pipelines, which are each in fluid communication with the one or more additional main pipelines, each one or more additional auxiliary pipeline including a hydrate slurry generating apparatus.

Referring to FIG. 8(b), an exemplary system 650 is provided for generating and recovering subsea dry hydrates using one or more hydrate slurry generating apparatus 655. Fluids from wells 661 are transported through a jumper to a hydrate slurry generating apparatus 655 having a heat exchanger with integral static mixers and/or static mixing valves 662. Hydrate formation/conversion occurs after each well 662 and before a manifold 664. The production fluids then pass from each heat exchanging unit to a subsea pump 663. During normal operation the subsea pump will provide boosting power (artificial lift); however, during shut-ins the pump will be put on full recycle to allow the continued formation of the hydrate slurry and to prevent coalescence of water droplets during the stagnant conditions. The fluids will then enter the manifold 664 and be directed to the flowlines 665. The flow line maybe dual tieback or single tieback depending on pigging needs. The flow line will direct fluids up to a platform or FPSO 667. At the host unit, the fluids may optionally require heating in a separator to melt the hydrates and to prevent agglomeration. The system may also optionally include a chemical injection system beginning with the umbilical 668. The umbilical may carry thermodynamic inhibitors and emulsion chemicals (inversion chemicals, stabilizers) to the subsea operations. Once at the umbilical termination assembly 669, the chemicals can be distributed to the different subsea architecture 670.

In conventional multi-well production systems, shut-ins and turn downs on the wells may have an impact on cold flow production. Due to the need to have turbulent flow regimes, a turn down or shut in of one well may reduce the flow rate and would be a disadvantage for the cold flow process for other wells.

The present systems which position a hydrate slurry generating apparatus after each well, optionally before a manifold, addresses the problem of turn down or shutting in wells (transient operation). Since each well has it's own hydrate slurry production system, operational events triggering turn downs or shut ins of other wells in the system will not have an effect on the overall hydrate slurry generation/transportation system. Additionally, if remediation is needed, thermodynamic inhibitor can be added directly to the area of concern which would be in the heat exchanger unit instead of kilometers down a pipeline away from the chemical source.

### Methods and Operation

The present invention includes methods of generating a hydrate slurry and methods for producing hydrocarbons from hydrocarbon source. Methods of generating a hydrate slurry include the steps of: (a) transporting hydrocarbons through a main pipeline, (b) flowing at least a portion of the hydrocarbons to a hydrate slurry generating apparatus of the present invention, and (c) forming a hydrate slurry. Methods of producing hydrocarbons from a hydrocarbon source include the steps of: (a) transporting a flow of hydrocarbons to a hydrate slurry generating apparatus, (b) forming a hydrate slurry with the hydrate slurry generating apparatus, and (c) transporting the hydrate slurry to a production facility.

Hydrate slurries are generated according to the present invention using: (a) methods which seed a hydrocarbon stream with dry hydrates, or (b) “unseeded methods”, wherein dry hydrates are not used to seed a hydrocarbon stream. Both seeded and unseeded methods may optionally be combined with conventional techniques for mitigating hydrate formation, including: the use of a modified pig with special pressure cleaning devices; subsea pig replacement devices operated by remote operated vehicles; high velocity, high-shear devices; mechanical scraping devices, including a rotating internal vane; near sonic pressure waves; and a water hammer

In one or more embodiments which utilize a seeding method, small diameter, dry hydrate particles are placed in an auxiliary pipeline adapted to be placed in fluid communication with a wellstream before startup, i.e., a cold-flow reactor, cold-reactor pipe or tube. The dry hydrate particles may be used to seed the full wellstream. A small fraction of the full wellstream is passed once through a cold-flow reactor. The dry hydrates could be loaded during or after construction of the pipeline, before operating the wet wellstream or before the wellstream starts producing water. Contrary to the common view of avoiding placing hydrates in a pipeline on purpose because of the general notion that hydrates in a shut-in pipeline might fuse into one large hydrate mass that would plug the pipeline, the present invention proves that the advantage of providing seed of dry hydrate is that the facility can be started using the same process that is designed for re-start after planned and unplanned shut-ins. The dry hydrates useful in this embodiment may be formed using any suitable method for forming dry hydrate particles.

Unlike other methods for delivering dry hydrate particles to wellstreams, the dry hydrate particles in one or more embodiment are not recycled in a loop. The continuous recycling of dry hydrates in a loop containing liquid water often leads to the continued growth of the hydrates and the formation of larger and larger hydrates that, if not continuously ground into smaller hydrates using a grinder or similar equipment, would ultimately grow large enough to cause plugging. Thus, preferably a recycle loop is not utilized to recycling hydrates.

In one or more other embodiments of the present invention, equipment, such as manifolds, valves, vessels, pipelines, jumpers, etc., may be pre-filled with a dry hydrate slurry during subsea installation by providing for pressure and low temperature to be maintained in the equipment during installation. The dry hydrate slurry would be preserved by low temperature and high pressure until the time to start up the production flowline. As dry hydrate slurries do not agglomerate under such conditions in the absence of a recycle loop, there is no difficulty maintaining fluid flow at startup. Therefore, the present invention could be employed with several different types of processes for hydrate management, including chemical injection, insulated pipe, cold flow processes of any kind, etc.

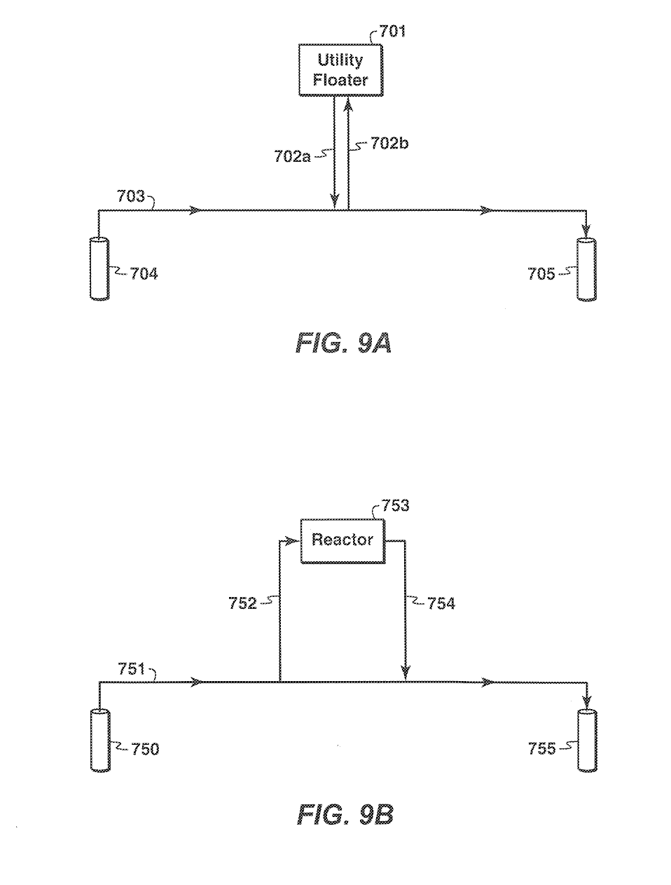

In another embodiment, dry hydrates are delivered to the cold-flow reactor subsea through a chemical injection umbilical. The dry hydrates could be formed in a separate reactor not associated or connected to the main pipelines for the wellstream. For example, FIG. 9(a) illustrates connections and equipment that may be employed in this embodiment.

The separate reactor may be: (a) on a platform, (b) onshore, or (c) in an FPSO-type vessel, exemplified generally in FIG. 9(a) by utility floater 701. The dry hydrates are carried through umbilical 702a in a liquid hydrocarbon stream to provide good slurry flow characteristics.

The pressure and temperature of the fluids in the umbilical are maintained within the hydrate stability parameters. This can be accomplished by using fluids from the wellstream to be treated or using a fluid that is best suited for the pressure-temperature envelope of the umbilical. The quantity of dry hydrates delivered by the umbilical is small compared to the full wellstream volume. The dry hydrates are delivered to subsea manifold 703 which is in fluid communication with well 704 and pipeline 705. Manifold fluids are delivered to the reactor in utility floater 701 through umbilical 702b.

Alternatively, instead of vertical umbilical delivery of fluids to a floater and solid dry hydrates returning to the pipeline, one can have the standard single umbilical that is used to deliver injectants from the facility near the outlet of the pipeline to the injection point near the well. Fluids removed from the pipeline at the processing facility would be used to generate a slurry of dry hydrates which would be delivered through the single umbilical to the injection point near the well. No additional storage facilities are required for chemical injectants because the injectant is water, oil, and natural gas which are found at the processing facility.

In one or more embodiments wherein seed hydrates are not utilized, i.e., unseeded methods, hydrates are generated subsea in a hydrate slurry generating apparatus, i.e., cold-flow reactor, as described above. During hydrate formation, a static mixer forms small water dispersions in oil that result in rapid conversion of water to hydrates without agglomeration. Alternatively, small water droplet dispersions may be formed by flowing a full wellstream through a nozzle or combination of nozzles and static mixers. However, nozzles typically result in a large differential pressure. No large differential pressure results from static mixing or from “sticky” hydrates, since the latter are avoided.

Unexpected shut-ins can be handled several ways. For example, thermodynamic inhibitors, such as methanol or glycols, may be injected upstream and/or downstream of the static mixing segment of the main pipeline before planned shut-in, during shut-in and/or after startup. Alternatively, low dose hydrate inhibitors may be injected upstream and/or downstream of the static mixing segment of the main pipeline before planned shut-in, during shut-in and/or after startup. Specifically, an anti-agglomerate may be injected before, during and/or after shut-in to facilitate hydrate slurry formation. In addition, if pumps are available for the artificial lift, proper positioning can allow the full wellstream to be recyled thus allowing for continued hydrate slurry formation and prevention of agglomeration by preventing the water droplets from coalescing.

The static mixing apparatus of the hydrate slurry generating apparatus may be placed above the full wellstream pipe at the point where fluids are sampled. If the static mixer is in an inclined position relative to the outlet of the dry hydrate reactor, dry hydrates will slump to the reactor inlet. Liquid water will drain back into the full wellstream pipe. In another example, the small-diameter pipe of the dry hydrate reactor can be lower than and displaced by the dry hydrated full wellstream downstream of the point where the seeds and the full wellstream mix. Dry hydrates can be re-started with the normal pipeline operating pressure. There is no need to de-pressurize the pipeline and restart at low pressure to avoid solid hydrate deposition and plugging.

An advantage of the hydrate slurry generating apparatus is that the seed cold-flow reactor will not need to be operated at low volumetric gas fraction to be effective in generating dry hydrates. The hydrate slurry generating apparatus containing the static mixer or mixers can be in fluid communication with the wellstream through an auxiliary pipeline, i.e., sidestream, taken from a main pipeline, i.e., wellstream, either directly or indirectly.

Alternatively, if the gas concentration is sufficiently low, the hydrate slurry generating apparatus can be placed directly in the wellstream itself In this embodiment, a portion of the wellstream pipeline itself serves as the cold-flow reactor for forming the dry hydrates. In one or more embodiments the gas volume fraction is less than 10 percent of full wellstream without the hydrate slurry generating apparatus. The gas volume fraction can be between about 0-50% with static mixers.

The main pipeline may split into two sections: (1) A cold flow section with the hydrate slurry generating apparatus, and (2) an unobstructed pipeline section for the purpose of bypassing the cold flow section while pigging the main pipeline. An advantage of the hydrate slurry generating apparatus is that the cold-flow reactor section will not need to be operated at low volumetric gas fraction to be effective in generating dry hydrates with static mixers. In this embodiment, the pipeline containing the hydrate slurry generating apparatus receives most or all of the fluid in the full wellstream directly from the pipeline. In this embodiment, a portion of the wellstream pipeline itself serves as the cold-flow reactor for forming the dry hydrates. The hydrate slurry generating apparatus serves to disperse the water and the gas in the wellstream fluids into smaller water and gas droplets that are relatively quickly and completely converted into dry hydrates without requiring seed hydrates. That is, the hydrates are formed directly in the full wellstream without a sidestream generator/reactor. Gas and/or water separation may be included in the main pipeline before the cold flow generating section.

Without being limited by theory, it is believed that water droplet diameter affects dry hydrate formation. When there is no gas phase, the water does not need to be dispersed in 1-30 micron droplets to form dry hydrates. Smaller water droplet diameters are believed to be generally better for dry hydrate formation, but it is believed that a wide range of water droplet diameters may be employed.

Thus, in one or more embodiments, the dry hydrates used in embodiments of the present invention are formed using water droplets having diameters less than or equal to about 30 microns, or less than or equal to about 15 microns, or less than or equal to about 10 microns, or less than or equal to about 7 microns.

Droplet diameter is known to depend on the droplet and continuous phase viscosity, shear rate (or fluid velocity), and interfacial tension between the droplet and continuous phase. In a hydrate slurry generating apparatus, the droplet diameter is decreased because shear rate is increased. The relationship between droplet diameter and the above factors is well known to those of skill in the art and can be calculated using known relationships.

The water droplets tend to coalesce downstream of the hydrate slurry generating apparatus. Gravity is a strong promoter of coalescence, so the hydrate slurry generating apparatus is preferably oriented vertically, or the reactor diameter may be made as large as practical to minimize coalescence during the hydrate formation stage. However, filling the entire pipeline with static mixers may impose unnecessary pressure drop. Shorter settle distances in the horizontal pipe are conducive to greater droplet coalescence, so proportionally little is gained by increased pipe diameter. Therefore, vertical orientation is the preferred method, though combinations of methods could be implemented.

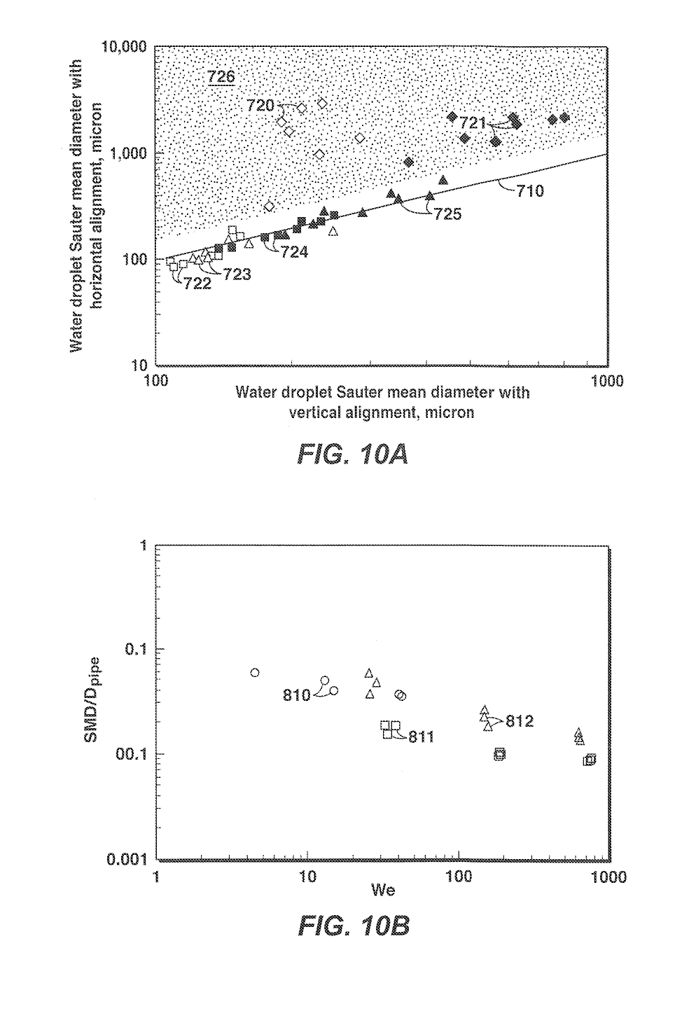

FIG. 10(a) shows a parity plot that compares water droplet size for vertical and horizontal orientation of the static mixer and subsequent tube section for a variety of oils or other hydrocarbons. Reference line 710 represents the 45-degree line for the plot. The symbols exemplified by points 720, 721, 722, 723, 724 and 725 show the plotted results for, respectively: Conroe crude oil, 2 m/s; dodecane, 2 m/s; Conroe crude oil, 10 m/s; Conroe crude oil, 5 m/s; dodecane 10 m/s; and dodecane 5 m/s. The shaded area in FIG. 10(a) denoted by reference numeral 726 represents the area of significant coalescence of droplets. As can be seen from FIG. 10(a), the vertically oriented static mixers maintain smaller droplet sizes more effectively than the horizontally oriented mixers.

To effectively package a vertically oriented static mixer assembly in the distance required for complete or nearly complete hydrate formation, one or more embodiments of the present invention may employ staging of alternating upward-downward flowing section in a dry hydrate reactor. Such an embodiment is illustrated in FIG. 1(a), which shows a series of bundled sections having upward flow sections with static mixer elements 25, followed by downward flow sections without static mixers. Partial or nearly complete hydrate formation can be accomplished horizontally with much fewer static mixers and much less distance than can complete conversion by static mixers. However, once dry hydrates are initiated, if the flow is at high Reynolds Number, there is not necessarily a need for more static mixers to complete the formation of hydrates to 100%.

A dry seed scale-up design according to one or more embodiments of the present invention may involve multiple staged reactors of increasing capacity. Staging would ensure the most effective conversion of all water in the wellstream to dry hydrate. An example of such an embodiment employing a three reactor design is shown in FIG. 7(b). In the three-reactor design, first reactor 731 takes approximately 1% of the liquids in wellstream 730 and converts the side-stream water to dry hydrate. Following first reactor 731 is a secondary reactor 732, where an additional 10% of wellstream liquids are diverted. The dry hydrate stream from the first reactor is fed into the second reactor to induce faster dry hydrate formation. Finally, the dry hydrate stream is fed back into the wellstream (the third reactor), which induces conversion of the remaining water to dry hydrate. The advantage of the staged reactor design is that greater heat and mass transfer can be obtained and smaller droplets maintained in the side streams, resulting in faster and more complete conversion of the water to dry hydrate.

Water droplet surface area is maximized by maximizing the fluid flow rate through the hydrate slurry generating apparatus, or in other words, increasing the Reynolds number. This requirement may lead to preference for small diameter vertical hydrate slurry generating apparatus designs versus large diameter horizontal hydrate slurry generating apparatus.

FIG. 9(b) shows a seed reactor design to initiate dry hydrate growth according to one embodiment of the invention. The design has the advantage that it is relatively simple, imposes no high-maintenance equipment, and doesn't enter a regime of “sticky” hydrate formation. Production fluids from well 750 enter manifold 751. Less than about 5%, alternatively less than about 1%, of the wellstream is diverted through sidestream 752 to hydrate slurry generating apparatus 753, i.e., dry hydrate reactor. The water in the wellstream fluids entering hydrate slurry generating apparatus 753 is used to form dry hydrate particles that are in turn fed back into the wellstream through return stream 754. In one or more embodiments, the dry hydrate particles have a diameter of about 1-30 microns, or about 1-20 microns, or about 1-10 microns, or about 1-5 micron. Upon introduction into the wellstream fluids in manifold 751 the dry hydrate particles will act as seed nuclei to cause the formation of dry hydrates in the wellstream fluid having diameters in the range of about 10-100 microns. In this way, the water in the full wellstream is converted into dry hydrates. The wellstream fluid containing the dry hydrates is then fed to pipeline 755.

In “Continuous formation of CO₂ hydrate via a Kenics-type static mixer,” Energy & Fuels, Vol. 18, pp. 1451-1456, 2004, which is herein incorporated by reference, author Tajima et al. published data for mean droplet diameter with Weber number for a stream of CO₂ in water (without a liquid hydrocarbon), from which a pumpable hydrate slurry was obtained for CO₂ sequestration in the ocean. Using a Lasentec® D600X particle size analyzer, water droplet distributions were measured, by the present inventors, as a function of the Weber number in both dodecane and in a crude oil, as shown in FIG. 10(b), with the Tajima et al. results. The data for water dispersions in oil is comparable to that of the CO₂ dispersions, indicating that the static mixer disperses the water droplets in oil as efficiently as with CO₂ in water. Referring to FIG. 10(b), the data points exemplified by points 810 represent the results reported by Tajima et al. for carbon dioxide in water, the data points exemplified by points 811 represent the results obtained by the present inventors for water in Conroe crude oil, and the data points exemplified by points 812 represent the results obtained by the present inventors for water in dodecane.

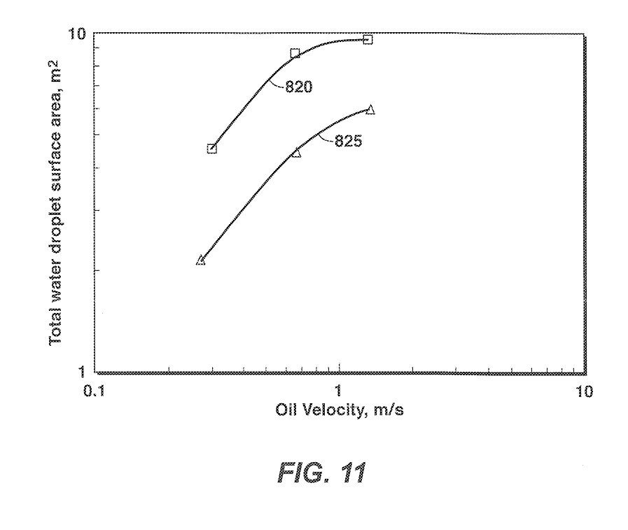

FIG. 11 shows that the total droplet surface area increases with velocity through the static mixers. The increased droplet surface area permits greater conversion of water and is conducive to dry hydrate growth. Referring to FIG. 11, curves 820 and 825 represent the total water droplet surface area versus oil velocity (at the outlet of a five-element static mixer) for Conroe crude oil and dodecane, respectively.

In one or more embodiment, dry hydrates are generated subsea in a hydrate slurry generating apparatus by excluding most of the gas phase. This is done by passive separation of liquids from gas. The hydrates formed by this method are not sticky. The low gas fluid forms small hydrate particles that disperse in oil with rapid conversion of water to hydrates without agglomeration. No large differential pressure results were observed in this embodiment. Since “sticky” hydrates were not generated, no large differential pressure was observed. One advantage of this embodiment is the reduction of the pressure drop anticipated with the use of the static mixers. The use of an ultra-low gas volume in a pipe where oil and water are flowing to form small diameter hydrates provides unexpected and surprising results.

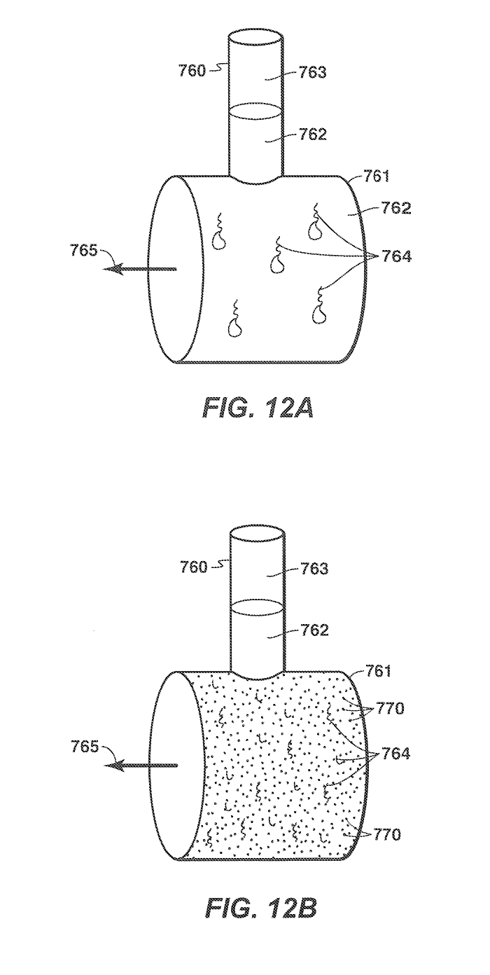

In one or more embodiments, the pipe is preferably over-filled (95% oil and 5% water) to eliminate the gas/water interface and hydrate plug formation. Dendritic hydrate formation can be forced by mass transfer limiting the gas phase in the oil phase. As shown in FIG. 12(a), dendrites forming on the water droplets do not contact a gas/water interface, since there is no separate gas phase. In FIG. 12(a), pipe 760 connects pipe 761 to a gas reservoir (or other hydrocarbon reservoir). Pipe 760 contains oil 762 over which a gas 763, for example methane or natural gas, is placed. Hydrate dendrites 764 are shown growing on water droplets. The direction of turbulent flow is indicated by arrow 765. Referring to FIG. 12(b), turbulent flow then causes the dendrites to separate from the water droplets. Turbulent flow eventually results in the dendrites 764 breaking off of the water droplets and ultimately into small granules 770. Total water conversion to hydrates occurs without hydrate agglomeration.

In flow loop experiments where a gas space is present above the liquid volume, “sticky” hydrates are formed. The “sticky” hydrates appear as large slush-like aggregates that induce large pressure drops across the loop.

In surprising contrast, dry hydrates are observed to form when little or no gas phase is present at the same formation conditions. These have the appearance of fine silt which would settle out when the fluid flow is stopped. While producing these dry hydrates, very little increase of pressure drop occurred across the loop.

In yet another embodiment, the present invention provides another passive method of forming small diameter dry hydrates by using a falling film reactor as the cold-flow reactor. The design of falling film reactors is well known in the chemical industry. For example, most detergents are manufactured in falling film reactors. There are both large scale and micro-reactor-scale falling film reactor designs. All of these reactors have the advantage of large surface-to-volume ratio that allows for enhanced process control and heat management. Various reactor designs incorporate single tubes, multi-tubes, and parallel plates. Hydrates formed by a falling film of water, oil, and gas will be small in diameter. Falling film reactors have no moving parts, making this process highly reliable for subsea and arctic applications.

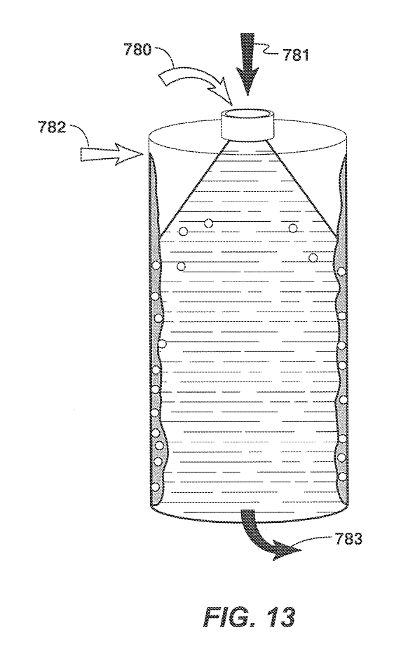

FIG. 13 shows another embodiment in which a dry hydrate seed falling film reactor has oil injected along the walls of the reactor. A water stream is injected as a mist by high pressure gas, which instigates water-limited hydrate growth. The falling oil film captures the dry hydrate seeds and delivers them to the wellstream, free of gas bubbles. Referring to FIG. 13, water and high pressure gas, indicated by reference numerals 780 and 781 respectively, are introduced into the top of the falling film reactor. Oil 782 is injected along the walls of the reactor. The dry hydrates in the falling oil film flow out from the reactor at 783.

The energy required for a falling film reactor can be provided by the temperatures of the reacting fluids by maintaining proper fluid flow ratios. An energy balance on a closed, falling film reactor can be determined using equations and methods well known to those of skill in the art. Such energy balance calculations show that the closed reactor system can be designed to produce hydrate without dependence on outside convection. A reactor would convey heat to the surroundings, and could be engineered with exterior fins to maximize convection.

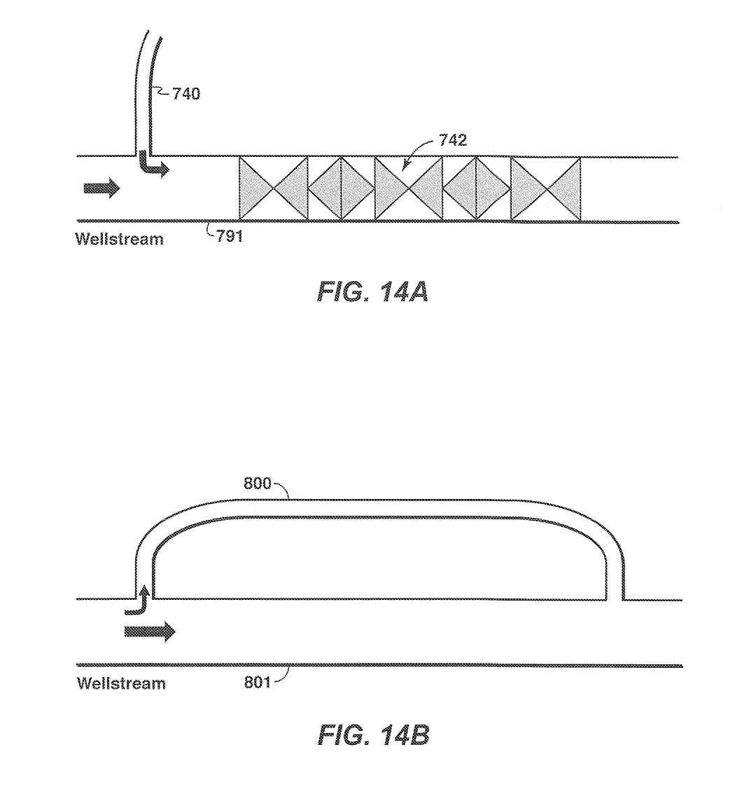

FIG. 14(a) illustrates another embodiment of the invention involving the application of a hydrate slurry generating apparatus in the main pipeline to increase heat transfer and mass transfer just downstream of dry hydrate injection. The dry hydrate can be injected through an umbilical or could be an input from a hydrate generating apparatus. In FIG. 14(a), dry hydrate seeds are introduced through inlet pipe 790 into wellstream fluids flowing in pipeline 791. A hydrate generating apparatus 792 is placed downstream of inlet pipe 790. As is well known in the art, the addition of static mixers could account for as much as 300% increase in heat transfer compared to a system with no mixers. See, for example, “Static mixing and heat transfer” by C. D. Grace in Chemical and Process Engineering, pp. 57-59, 1971, which is incorporated herein by reference. Therefore, by addition of the hydrate generating apparatus, the reactor length could be reduced to ⅓ the required length in the case where no static mixers were used, while achieving the same heat transfer rates. Use of multiple heat exchangers further facilitates reduction of reactor length, while achieving similar heat transfer rates.

In another embodiment, a small rough-walled pipe achieves the same result as static mixers, i.e., high shear fields for small droplet formation. The same pipe may be of the same sizes as the pipe discussed above with regard to static mixers in the cold-flow reactor concept. FIG. 10 shows an example of such an embodiment for the implementation of rough-walled tubing to cause mass transfer increase during hydrate formation. Higher shear at the wall will cause water droplets to be broken into smaller droplets, thereby increasing mass transfer. Referring to FIG. 14(b), a rough-walled tube 800 is joined to pipeline 801 as shown. An auxiliary pipeline of the wellstream fluids is taken from main pipeline 801 and flows into rough-walled pipe 800. The auxiliary pipeline ultimately rejoins the wellstream fluid flow downstream of the point at which the auxiliary pipeline enters rough-walled tube 100.

The pressure drop per unit length that results from a dodecane suspension flowing in a tube can be readily determined as a function of Re (Reynolds number) at several We (Weber number) by those of skill in the art. As can be determined from FIG. 10(b), at We>200 the droplet size does not change significantly. Therefore, in one or more embodiments, the rough-walled pipe will have a sufficiently small diameter that We of at least 200 is produced.

As an example of the foregoing, if a 600 ft long hydrate slurry generating apparatus was used, having a ½ inch diameter pipeline, the flow rate at We=200 would be 2.23 ft/s and Re=7350. The pressure drop across the hydrate slurry generating apparatus would be 114 psi. The residence time of fluid in the apparatus would be 5 minutes. Freer et al. in “Methane hydrate film growth kinetics,” Vol. 185, pp. 65-75, 2001 measured methane hydrate film growth rates of 325 micron/s at 38° F. and 1314 psia. Therefore, 100 micron diameter droplets should be consumed on the order of a second and should have sufficient time for conversion.

The formation of dry hydrates and the growth of such hydrates are affected by many factors. The gas composition in the reactor and the pipeline preferably does not change during hydrate formation as this may decrease the thermodynamic potential and kinetic driving force for hydrate formation, thereby slowing the hydrate formation rate and requiring that the reactor be designed much longer than otherwise expected. The following factors play a large role in whether composition changes significantly: 1) operating pressure, wherein higher operating pressure is preferred, such as greater than 3000 psig; 2) water cut, wherein lower amounts of water are preferred, such as less than 10 volume percent; and 3) initial gas composition, wherein the a gas composition similar to the composition of the hydrate is more preferred, such as greater than 8 mole % ethane, propane, butanes and/or pentanes.

High operating pressures are preferred since proportionally smaller mole fractions of gas are consumed for the same amount of hydrate formed. Lower water cut results in less hydrate formed, so smaller mole fractions of gas are consumed. The azeotrope condition is where hydrate is consuming the gas in the same proportion as the gas composition, resulting in no composition change.

The hydrate gas fraction, whether dissolved in liquid oil or present as a gas phase, is preferably sufficient to convert all of the water in the reactor to dry hydrates. The preferred condition is for the hydrate gas components to be dissolved in the oil phase. The reason is that large gas bubbles in the reactor may lead to large hydrate particles that trap liquid water that is not completely converted to hydrates, resulting in “sticky” hydrates. Either the water quantity is preferably less than the dissolved hydrate gases can convert to hydrates or the oil is preferably capable of being re-saturated with hydrate gases before the fluids exit the reactor. Therefore, a seed reactor design will take into account the rate of consumption of hydrate gases dissolved in the liquid and the rate of re-saturation of the oil.

Preferably, the temperature of the dry hydrate reactor balances the need to keep the reactor short by using as low a temperature as is possible, and keeping the hydrate formation rate slow enough to avoid agglomeration of partially converted water droplets. Similarly, the temperature of the mixing zone of dry hydrate seeds with the full wellstream liquid water is crucial as the liquid water is preferably prevented from forming sticky hydrates faster than the dry hydrate seeds convert the liquid water to dry hydrates.

In another aspect of the invention, any one or a number of the above methods and systems for transporting hydrocarbons can be used in a method to produce hydrocarbons from the wellhead. The hydrocarbons are preferably in liquid form and 50% or more of the total liquid volume is hydrocarbon and less than 50% of the total pipeline volume is gas.

In one or more embodiments, provided are methods of producing hydrocarbons composed of the steps of: (a) providing a well in a hydrocarbon reservoir; (b) producing a wellstream comprising hydrocarbons and water from said well; (c) diverting a sidestream of said wellstream into a hydrate slurry generating apparatus; (d) passing said sidestream through the hydrate slurry generating apparatus; (e) converting at least a portion of the water in said sidestream to dry hydrates without recycling said dry hydrates through the hydrate slurry generating apparatus; (f) feeding said dry hydrates into said wellstream to convert substantially all of the water in said wellstream to dry hydrates, thereby forming a wellstream comprising dry hydrates and hydrocarbons; (g) transporting said wellstream comprising dry hydrates and hydrocarbons through a pipeline; (h) recovering said hydrocarbons from said pipeline. Without being limited by theory, it is believed that when dry hydrate seeds are combined with a stream containing liquid water, the seed particle diameters grow approximately proportionally to the cube root of the water-to-seed volume ratio. The produced stream could be subjected to the hydrate slurry generating apparatus in the region within about a kilometer, or one-half kilometer, or one-third kilometer of the source, usually about five minutes or seven minutes, or ten minutes of flow time and distance.

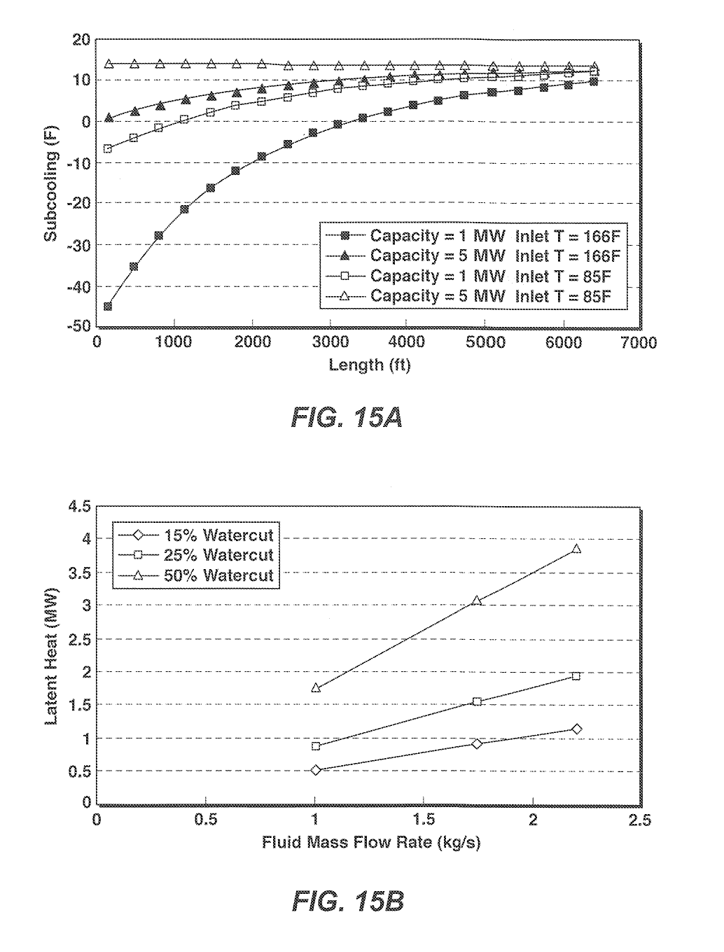

A factor in designing once-through systems is the length of pipe required to cool the fluid's sensible and latent heat from hydrate formation versus rate of coalescence. FIGS. 15(a) & (b) show an example of the distances required to cool a stream to the hydrate formation region (sensible heat) with varying heat duties and inlet temperatures. FIG. 15(a) illustrates the distance required for a given heat duty to subcool a stream of fluids with varying inlet well temperatures (Subcooling=Thydrate equilibrium−Tambient). FIG. 15(b) shows the length of pipe needed to cool a fluid down to the hydrate formation temperature with inlet temperatures of 85° F. and 166° F.

As can be seen in these figures, large amounts of energy are needed for rapid cooling of the stream (5 MW for 166° F. and 2 MW for 85° F.). Without heat exchangers, distances can range from 500 to over 3000 ft which could allow ample time for water droplet coalescence before entering the hydrate formation region. This could cause the droplets to become large or even a free water phase to develop which could result in incomplete hydrate conversion and blockage of the pipeline. In addition to the sensible heat, the exothermic latent heat of hydrate formation would increase the heat duties depending on the watercut as shown in FIG. 15(b).

FIG. 15(b) shows an example of a scenario of latent heat of hydrate formation with varying fluid flow rate and watercut and assumes 100% conversion of water to hydrate. FIG. 15(b) shows that as the fluid mass flow rate increases the amount of latent heat increases due to the increased flow of water. Additionally, as watercut increases the amount of latent heat also increases. Using heat exchangers in conjunction with static mixers aids in concentrating hydrate formation/conversion in a controlled portion of the production system throughout the field life with the ability to have constant shear.

As described above, anti-agglomerates, hydrate inhibitors, static mixer apparatus, and combinations thereof are used to make flowable hydrate slurries or reduce the quantity of hydrate formation. Flowable hydrate slurries are achievable at various watercuts, but more often at low water cuts, e.g., about 0% to about 50% watercut, and at high water cut, e.g., about 70% to about 100%. At intermediate watercuts, e.g., about 50% to about 70% watercut, some hydrate slurries have reduced flowability or are not flowable. The exact range of watercuts varies depending on oils and brines. A hydrate management strategy may increase the flowability of hydrate slurries in an intermediate water cut and thereby bridge the gap between lower and higher water cut ranges.

In one or more embodiments wherein a flowline is fed by multiple wells over the life of a hydrocarbon field, one or more wells with high water production are shut in as the average watercut over all wells feeding the flowline approaches the upper limit of the low water cut range. The production from these high water cut wells is then resumed when the average watercut over all wells feeding the flowline exceeds the lower limit of the high water cut range. Optionally the use of anti-agglomerate is uninterrupted during the life of the field.

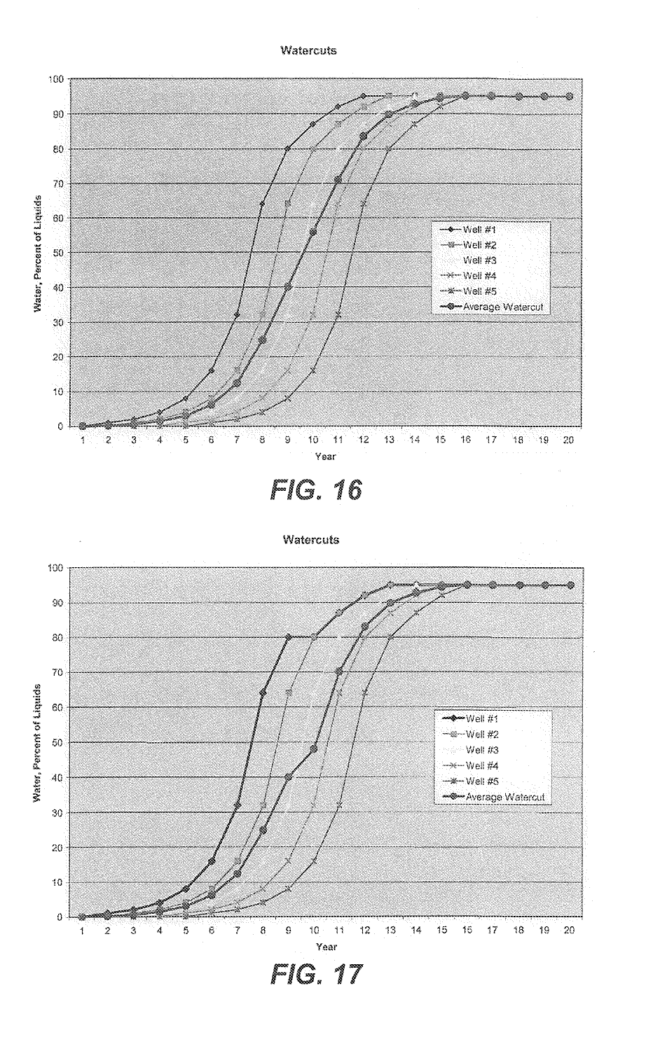

For example, FIG. 16 shows a set of water production profiles for five wells that flows into a common flowline. Typically, the five wells are connected to one or more manifolds by well jumpers. By keeping the location of the manifold(s) central to the wells, no hydrate inhibitor is required for steady state flowing conditions since the temperature of the fluids in the five jumpers will be higher than the hydrate formation temperature by design. Anti-agglomerate is optionally injected at the manifold(s).

When the fluids from the five wells are combined at the manifold(s), the temperature of the combined stream is initially above the hydrate formation temperature. After some distance of pipe, the fluid temperature drops below the hydrate formation temperature. Hydrates formed have conventional flowability as long as the watercut in the flowline is within the low watercut range or the high watercut range.

As shown in FIG. 1, there is a period of time that the combined stream in the flowline is within the intermediate watercut range where hydrates have reduced flowability due to slurry viscosity and pipeline plugging. In such instances, it is difficult to operate the flowline according to the expected production profile unless more water is added or removed.

Referring to FIG. 2, which shows an example of the same five wells as in FIG. 1, except that well #1, which has the highest water production rate in year eight, is shut in for a period of time, e.g., 1 year, before the combined fluids in the flowline would have exceeded the maximum of the lower water cut range for flowable hydrate slurries in year nine, which in FIG. 2 is 50% watercut.

When the well with the highest water production rate is shut in, the combined fluids from the remaining four wells have a watercut below the maximum of the lower water cut range, i.e., below 50%. This configuration may continue producing fluids with flowable hydrate slurry until the water production rate from the four wells corresponds with the maximum of the lower watercut range, which in this example is 50%. Before this occurs, one determines whether resuming production of well #1 increases the water production rate sufficiently that the combined fluids have a watercut that is greater than the lower limit of the high water cut range, which in this example is 70%. This configuration assumes that the water production rate of well #1 does not change while it is shut in. Alternatively, another well, i.e., in addition to well #1, may be shut in the maintain the water production rate below the maximum of the lower water cut range.

### Embodiments

Further embodiments of the present invention are provided below in embodiments A-CCC:

Embodiment A: A static mixer apparatus, comprising:

an inlet orifice,

an outlet orifice in fluid communication with the inlet orifice, and

a mechanism fluidly coupled between the inlet and outlet orifices, the mechanism configurable between a first state and a second state, wherein fluid flow between the inlet and outlet orifices is substantially unimpeded when the mechanism is in the first state and a static mixer element impinges upon the fluid flow when the mechanism is in the second state.

Embodiment B: The static mixer apparatus of embodiment A, wherein the static mixer element comprises a plurality of groups of static mixers.
Embodiment C: The static mixer apparatus of embodiment A or B, wherein:

the mechanism comprises a retractable plate;

the static mixer element comprises a plurality of holes in the retractable plate;

the retractable plate is extracted from the fluid flow in the first state; and

the retractable plate is inserted into the fluid flow in the second state.

Embodiment D: The static mixer apparatus of embodiment C, wherein each hole of the static mixer element includes a static mixer.
Embodiment E: The static mixer apparatus of embodiment A or B, wherein the mechanism comprises: (a) a first channel substantially devoid of obstructions for fluidly coupling the inlet and outlet orifices when the mechanism is in the first state; and (b) a second channel including the static mixer element for fluidly coupling the static mixer element between the inlet and outlet orifices when the mechanism is in the second state.
Embodiment F: The static mixer apparatus of embodiment E, wherein the mechanism rotates on an axis between the first state and the second state.
Embodiment G: The static mixer apparatus of embodiment A or B, wherein:

the mechanism includes a diverter having a channel substantially devoid of obstructions for fluidly coupling the inlet and outlet orifices when the mechanism is in the first state; and

the diverter directs the fluid flow around the diverter and across the static mixer element when the mechanism is in the second state.

Embodiment H: The static mixer apparatus of embodiment G, wherein the diverter rotates about an axis and the axis is substantially perpendicular to the channel.
Embodiment I: The static mixer apparatus of embodiment A or B, wherein the mechanism comprises a radially symmetrical shape having a center channel there through, the center channel substantially coincident with a center axis of the radially symmetrical shape and configured to fluidly couple the inlet and outlet orifices when the mechanism is in the first state.
Embodiment J: The static mixer apparatus of embodiment I, wherein the center channel is substantially devoid of obstructions.
Embodiment K: The static mixer apparatus of embodiment I or J, wherein the radially symmetrical shape rotates about an axis substantially perpendicular to the center axis.
Embodiment L: The static mixer apparatus of embodiment K, wherein the static mixer element comprises one or more static mixers fixedly coupled to an outer surface of the radially symmetrical shape and along at least a portion of a cross section of the radially symmetrical shape such that the fluid flow is diverted through the static mixer element when the mechanism is in the second state and the static mixer element is substantially removed from the fluid flow when the mechanism is in the first state.
Embodiment M: The static mixer apparatus of embodiment A or B, wherein:

the mechanism comprises a retractable channel,

the static mixer element is located in the retractable channel;

the retractable channel is extracted from the fluid flow in the first state; and

the retractable channel is inserted into the fluid flow in the second state.

Embodiment N: The static mixer apparatus of embodiment M, wherein the retractable channel is configured to divert substantially all of the fluid flow through the static mixer element when the mechanism is in the second state.
Embodiment O: The static mixer apparatus of any of embodiments A-N, wherein the mechanism is configured to pass a pig substantially unimpeded between the inlet and outlet orifices when the mechanism is in the first state.
Embodiment P: The static mixer apparatus of embodiment O, wherein the pig is configured to remove buildup from a section of pipe in fluid communication with the apparatus.
Embodiment Q: The static mixer apparatus of embodiment P, wherein the buildup is wax, scale, or a combination thereof.
Embodiment R: The static mixer apparatus of embodiment P, wherein the buildup is a byproduct of a cold-flow process implemented in connection with a system for transporting a flow of wellstream hydrocarbons.
Embodiment S: The static mixer apparatus of any of embodiments O-R, wherein the pig is configured to provide chemical dosing in a section of pipe in fluid communication with the mechanism.
Embodiment T: The static mixer apparatus of any of embodiments O-S, wherein the pig is configured to provide corrosion surveillance in a section of pipe in fluid communication with the mechanism.
Embodiment U: A system for selectively impinging a static mixer element upon a fluid flow:

a production facility;

a production line; and

a static mixer apparatus fluidly coupled in-line with the production line wherein the static mixer apparatus includes:
an inlet orifice;
an outlet orifice in fluid communication with the inlet orifice; and
a mechanism fluidly coupled between the inlet and outlet orifices, the mechanism configurable between a first state and a second state, wherein fluid flow between the inlet and outlet orifices is substantially unimpeded when the mechanism is in the first state and a static mixer element impinges upon the fluid flow when the mechanism is in the second state.
   Embodiment V: A hydrate slurry generating system comprising:

a main pipeline,

one or more static mixer apparatus of any of embodiments A-T,

wherein the one or more static mixer apparatus are located in the main pipeline and are fluidly coupled in-line with the main pipeline.
Embodiment W: A hydrate slurry generating system comprising:

a main pipeline,

an auxiliary pipeline, which is in fluid communication with the main pipeline,

one or more static mixer apparatus of any of embodiments A-T,

wherein the one or more static mixer apparatus are located in the sidestream and are fluidly coupled in-line with the sidestream.
Embodiment X: A hydrate slurry generating system comprising:

a main pipeline,

two or more auxiliary pipelines, which are each in fluid communication with the main pipeline,

one or more static mixer apparatus of any of embodiments A-T,

wherein the one or more static mixer apparatus are locate in the two or more auxiliary pipelines and are fluidly coupled in-line with the two or more auxiliary pipelines.
Embodiment Y: The hydrate slurry generating system of embodiment X, wherein the two or more auxiliary pipelines are in direct fluid communication with each other.
Embodiment Z: The hydrate slurry generating system of any of embodiments W-Y, further comprising one or more static mixer apparatus located in the main pipeline.
Embodiment AA: The hydrate slurry generating system of any of embodiments W-Z, wherein the one or more auxiliary pipelines comprise a pipe with roughened walls.
Embodiment BB: The hydrate slurry generating system of any of embodiments U-AA, wherein the one or more static mixers are substantially free of energized equipment.
Embodiment CC: The hydrate slurry generating system of any of embodiments U-BB, further comprising an injection umbilical connected to a production facility above sea level.
Embodiment DD: The hydrate slurry generating system of any of embodiments U-CC, wherein the mechanism is configured to pass a pig substantially unimpeded between the inlet and outlet orifices when the mechanism is in the first state.
Embodiment EE: The hydrate slurry generating system of embodiment DD, wherein the pig is configured to remove buildup from the production line.
Embodiment FF: The hydrate slurry generating system of embodiment EE, wherein the buildup is wax, scale or a combination of wax and scale.
Embodiment GG: The hydrate slurry generating system of any of embodiments DD-FF, wherein the pig is configured to provide chemical dosing in the production line.
Embodiment HH: The hydrate slurry generating system of any of embodiments DD-GG, wherein the pig is configured to provide corrosion surveillance of the production line.
Embodiment II: A method of producing hydrocarbons from a wellstream comprising the steps of:

(a) transporting a flow of wellstream hydrocarbons to a system of any of embodiments U-II,

(b) forming a hydrate slurry with the system,

(c) transporting the hydrate slurry to a production facility.

Embodiment JJ: A hydrate slurry generating apparatus for generating a hydrate slurry comprising:

(a) a pipeline,

(b) one or more heat exchangers disposed within the pipeline, and

(c) one or more static mixers disposed within the pipeline.

Embodiment KK: The hydrate slurry generating apparatus of embodiment JJ, wherein the one or more static mixers is a static mixer apparatus of any of embodiments A-T.
Embodiment LL: The hydrate slurry generating apparatus of embodiment JJ or KK, wherein the one or more heat exchangers are parallel heat exchangers, cross flow heat exchangers, counter flow heat exchangers, or combinations thereof.
Embodiment MM: The hydrate slurry generating apparatus of embodiment JJ or LL, wherein the one or more heat exchangers are selected from the group consisting of: (a) once-through, tube bank heat exchangers, (b) a tube bank heat exchanger that divides the mainstream into two or more smaller streams, (c) shell-and-tube heat exchangers, (d) plate heat exchangers, (e) fin heat exchangers, or (f) combinations thereof.
Embodiment NN: The hydrate slurry generating apparatus of any of embodiments JJ-MM, wherein the one or more heat exchanger and one or more static mixers are combined in a housing comprising a pipe bundle, an inlet, and an outlet.
Embodiment OO: The hydrate slurry generating apparatus of any of embodiments JJ-NN, further comprising a one or more pumps in fluid communication with the pipeline.
Embodiment PP: The hydrate slurry generating apparatus of any of embodiments JJ-OO, further comprising a one or more valves adapted to control the flow of hydrocarbons through the pipeline to adjust for changing heat transfer requirements.
Embodiment QQ: The hydrate slurry generating apparatus of any of embodiments JJ-PP, wherein the pipeline is in fluid communication with a main pipeline.
Embodiment RR: A hydrate slurry generating apparatus comprising:

(a) a main pipeline,

(b) an auxiliary pipeline comprising at least one cold-flow reactor comprising:
(i) one or more pumps in fluid communication with the auxiliary pipeline,
(ii) a housing comprising:
   a pipe bundle,
   a plurality of static mixers disposed within the pipe bundle, and
   a plurality of heat-exchanger fins mounted upon the pipe bundle thereby facilitating heat transfer.
      Embodiment SS: A hydrate slurry generating system comprising:

a first main pipeline in fluid communication with a first hydrocarbon source,

a first auxiliary pipeline in fluid communication with the first main pipeline, the first auxiliary pipeline comprising:
a plurality of static mixers disposed within the first auxiliary pipeline, and
a plurality of heat exchangers coupled to the first auxiliary pipeline,

one or more additional main pipelines, which are each in fluid communication with one or more additional hydrocarbon sources, and

one or more additional auxiliary pipelines, which are each in fluid communication with the one or more additional main pipelines, each one or more additional auxiliary pipeline comprising:

a plurality of static mixers disposed within the auxiliary pipeline, and
a plurality of heat exchangers coupled to the auxiliary pipeline.
   Embodiment TT: The hydrate slurry generating system of embodiment SS, further comprising a manifold in fluid communication with the first main pipeline and the one or more additional main pipelines.
   Embodiment UU: The hydrate slurry generating system of embodiments SS or TT, further comprising flowlines in fluid communication with: (a) the first main pipeline, (b) the one or more additional main pipelines, (c) a production facility, and optionally, (d) a source of pipeline pigs.
   Embodiment VV: The hydrate slurry generating system of any of embodiments TT-UU, further comprising a chemical injection system in fluid communication with the first auxiliary pipeline and the one or more additional auxiliary pipelines.
   Embodiment WW: The hydrate slurry generating system of any of embodiments TT-VV, further comprising a production facility.
   Embodiment XX: The hydrate slurry generating system of any of embodiments TT-WW, wherein the hydrocarbon source is a well or tank.
   Embodiment YY: A method of generating a hydrate slurry comprising the steps of: (a) transporting hydrocarbons through a main pipeline, (b) flowing at least a portion of the hydrocarbons to the apparatus of any of embodiments JJ-RR, (c) forming a hydrate slurry.
   Embodiment ZZ: A method of generating a hydrate slurry comprising the steps of: (a) transporting hydrocarbons to a system of any of embodiments SS-YY, and (b) forming a hydrate slurry.
   Embodiment AAA: The method of embodiment YY or ZZ, wherein a hydrate slurry is formed in an arctic environment or subsea environment.
   Embodiment BBB: A method for producing hydrocarbons from a wellstream comprising the steps of: (a) transporting a flow of wellstream hydrocarbons to the apparatus of any of embodiments JJ-RR, (b) forming a hydrate slurry with the apparatus, (c) transporting the hydrate slurry to a production facility.
   Embodiment CCC: A method for producing hydrocarbons from a wellstream comprising the steps of: (a) transporting a flow of wellstream hydrocarbons to the system of any of embodiments SS-YY, and (b) forming a hydrate slurry.

The exemplary embodiments discussed above have been shown by way of example. However, it should again be understood that the inventions provided herein are not intended to be limited to a particular embodiment disclosed herein. Indeed, the present inventions cover all modifications, equivalents, and alternatives falling within the spirit and scope of the invention as defined by the following appended claims.

What is claimed is:

1. A hydrate-slurry generating apparatus comprising:
(a) a pipeline,
(b) one or more heat exchangers disposed within the pipeline, and
(c) one or more static mixers disposed within the pipeline.

2. The hydrate-slurry generating apparatus of claim 1, wherein the one or more static mixers is a piggable static mixer apparatus.

3. The hydrate-slurry generating apparatus of claim 1, wherein the one or more heat exchangers are parallel heat exchangers, cross flow heat exchangers, counter flow heat exchangers, or combinations thereof.

4. The hydrate-slurry generating apparatus of claim 1, wherein the one or more heat exchangers are selected from the group consisting of: (a) once-through, tube bank heat exchangers, (b) a tube bank heat exchanger that divides the mainstream into two or more smaller streams, (c) shell-and-tube heat exchangers, (d) plate heat exchangers, (e) fin heat exchangers, or (f) combinations thereof.

5. The hydrate-slurry generating apparatus of claim 1, wherein the one or more heat exchanger and one or more static mixers are combined in a housing comprising a pipe bundle, an inlet, and an outlet.

6. The hydrate-slurry generating apparatus of claim 1, further comprising one or more pumps disposed within the pipeline.

7. The hydrate slurry generating apparatus of claim 1, further comprising a one or more valves adapted to control the flow of hydrocarbons through the pipeline to adjust for changing heat transfer requirements.

8. The hydrate slurry generating apparatus of claim 1, wherein the pipeline is in fluid communication with a main pipeline.

9. A hydrate slurry generating apparatus comprising:
(a) a main pipeline,
(b) an auxiliary pipeline comprising at least one cold-flow reactor comprising:
(i) one or more pumps in fluid communication with the auxiliary pipeline,
(ii) a housing comprising:
a pipe bundle,
a plurality of static mixers disposed within the pipe bundle,
a plurality of heat-exchanger fins mounted upon the pipe bundle thereby facilitating heat transfer.

10. A hydrate slurry generating system comprising:
a first main pipeline in fluid communication with a first hydrocarbon source,
a first auxiliary pipeline in fluid communication with the first main pipeline, the first auxiliary pipeline comprising:
a plurality of static mixers disposed within the first auxiliary pipeline,
a plurality of heat exchangers coupled to the first auxiliary pipeline,
one or more additional main pipelines, which are each in fluid communication with one or more additional hydrocarbon sources,
one or more additional auxiliary pipelines, which are each in fluid communication with the one or more additional main pipelines, each one or more additional auxiliary pipeline comprising:
a plurality of static mixers disposed within the auxiliary pipeline,
a plurality of heat exchangers coupled to the auxiliary pipeline,

11. The hydrate slurry generating system of claim 10, further comprising a manifold in fluid communication with the first main pipeline and the one or more additional main pipelines.

12. The hydrate slurry generating system of claim 1, further comprising flowlines in fluid communication with: (a) the first main pipeline, (b) the one or more additional main pipelines, (c) a production facility, and optionally, (d) a source of pipeline pigs.

13. The hydrate slurry generating system of claim 10, further comprising a chemical injection system in fluid communication with the first auxiliary pipeline and the one or more additional auxiliary pipelines.

14. The hydrate slurry generating system of claim 10, further comprising a production facility.

15. The hydrate slurry generating system of claim 10, wherein the hydrocarbon source is a well or tank.

16. A method of generating a hydrate slurry comprising the steps of:
(a) transporting hydrocarbons through a main pipeline,
(b) flowing at least a portion of the hydrocarbons to the apparatus of any of embodiments JJ-RR, and
(c) forming a hydrate slurry.

17. A method of generating a hydrate slurry comprising the steps of:
(a) transporting hydrocarbons to a system of claim 10, and
(b) forming a hydrate slurry.

18. The method of claim 17, wherein a hydrate slurry is formed in an arctic environment or subsea environment.

19. A method for producing hydrocarbons from a wellstream comprising the steps of:
(a) transporting a flow of wellstream hydrocarbons to the apparatus of claim 9,
(b) forming a hydrate slurry with the apparatus, and
(c) transporting the hydrate slurry to a production facility.

20. A method for producing hydrocarbons from a wellstream comprising the steps of:
(a) transporting a flow of wellstream hydrocarbons to the system of claim 10, and
(b) forming a hydrate slurry.
